(19) United States
(12) Patent Application Publication
(10) Pub. No.: US 2013/0145016 A1
(43) Pub. Date: Jun. 6, 2013

(54) METHODS AND APPARATUSES FOR DOMAIN MANAGEMENT

(71) Applicants: Luc Vantalon, Sunnyvale, CA (US); Paolo Siccardo, Los Altos, CA (US)

(72) Inventors: Luc Vantalon, Sunnyvale, CA (US); Paolo Siccardo, Los Altos, CA (US)

(21) Appl. No.: 13/408,943

(22) Filed: Feb. 29, 2012

Related U.S. Application Data
(60) Provisional application No. 61/565,876, filed on Dec. 1, 2011.

(51) Int. Cl. G06F 15/173

(52) U.S. Cl. 709/224; 709/223; 709/225

(57) ABSTRACT

The distribution of media content within a subscriber domain is controlled at a server. A subscriber domain is defined as an association including one or more subscriber devices, which can be protected with different Digital Rights Management (DRM) systems and one or more gateways, which can source different media content, with different format using different content distribution networks. The server is responsible for distributing, authorizing and monitoring media content within a subscriber domain of devices.

This application claims the benefit of U.S. Provisional Application No. 61/565,876, filed on Dec. 1, 2011, which is incorporated by reference herein in its entirety.

### FIELD

At least some embodiments as described herein relate generally to providing, authorizing and monitoring the distribution of media content within a subscriber domain of devices.

### COPYRIGHT NOTICE

The present description includes material protected by copyrights, such as illustrations of graphical user interface images. The owners of the copyrights, including the assignee, hereby reserve their rights, including copyright, in these materials. The copyright owner has no objection to the facsimile reproduction by anyone of the patent document or the patent disclosure, as it appears in the patent and trademark office file or records, but otherwise reserves all copyrights whatsoever. Copyright Digital Keystone, Inc. 2012.

### BACKGROUND

Advances in multimedia technology provide various ways to deliver multimedia content to a user. For example, video on demand (VOD) or audio and video on demand (AVOD) are systems which allow users to select and watch/listen to video or audio content on demand on televisions and personal computers.

Television VOD systems either stream content through a set-top box, a computer or other device, allowing viewing in real time, or download it to a device such as a computer, digital video recorder (also called a personal video recorder) or portable media player for viewing at any time. The majority of cable- and telco-based television providers offer both VOD streaming, including pay-per-view and free content, whereby a user buys or selects a movie or television program and it begins to play on the television set almost instantaneously, or downloading to a DVR rented from the provider, or downloaded onto a pc, for viewing in the future.

Internet television, using the Internet, is an increasingly popular form of video on demand. Some video distribution systems, for example, Netflix, Inc., provides on-demand media over the Internet to a subscriber.

Some other video distribution systems, for example, YouTube provide a video-sharing website, on which users can upload, view and share videos. A user can search for a video on the video-sharing website and obtain as a result of search a list of uniform resource locators (URLs). The user can select one of the URLs and start watching the content. The video distribution system, such as YouTube can distribute only the content from a site that is controlled by the operator of this system.

Existing media player computer programs, for example iTunes, are used for playing, downloading, and organizing digital music and video files on desktop or laptop computers. For example, iTunes can connect to the iTunes store to purchase and download music, and other media content. iTunes, however is not being able to transfer media from one type of a portable device to another. The existing media player programs, such as iTunes, are architected for a uniform population of player devices. For example, iTunes cannot play on a Samsung TV, on a Sony tablet, or on a Nokia phone.

Existing video distribution systems, for example, YouTube and Netflix do not customize the content navigation. They do not include local content sources and do not modulate their offering based on player profiles. The existing video distribution systems do not manage geo-localization at a home domain. The existing video distribution systems integrate a single content contribution network and do not offer a choice of content distribution path options.

Currently content distribution, authorization and monitoring functions are embedded at a content server source such as YouTube or Netflix, within a content distribution network (CDN), and/or within proprietary software in media players such as iTunes.

Existing vertically integrated video distribution system, such as iTunes, only know how to register and authorize single-technology devices. The existing video distribution systems do not manage devices of different technologies or digital rights management (DRM) capabilities. Additionally, the existing video distribution systems do not manage assets with different distribution rules. Furthermore, the existing video distribution systems do not manage domains with different entitlement rights.

### SUMMARY

Exemplary embodiments of methods and apparatuses to provide one or more subscriber domain management services are described. A subscriber domain is defined as an association of one or more content source (“gateways”), and one or more content sink (“subscriber device”), one or more entitlements for a class or a specific media asset, and one or more domain rights. Gateways can be provisioned for a domain by an operator. In at least some embodiments, a gateway can be shared across multiple domains in an access network or over the Internet (“network gateway”). In at least some other embodiments, a gateway is dedicated to an individual domain, such as a gateway installed within the home (“home gateway”).

In at least some embodiment, a gateway can be accessed through multiple content distribution paths, which can be identified by one or more URLs, or one or more IP addresses.

In at least some embodiment, the media asset can be offered under one or more streaming formats, one or more file download options, or a combination thereof. The media asset can be video, music, application, game, or a combination thereof.

In at least some embodiments, a domain management service includes catalog adjustment at a server to provide media content within a subscriber domain.

In at least some embodiments, another domain management service leverages the data associated to the subscriber domain to authorize the distribution of media content within the devices of the domain based on the established distribution paths with the associated gateways and the capabilities of the devices.

In at least some embodiments, another domain management service includes monitoring and recording the distribution of media content to the devices of the domain with enough details to enable domain analytics.

In at least some embodiments, some of the subscriber domain details are provided by the associated gateways. Catalog up-loads, content distribution path determination results and playback state transition reports are recorded.

In at least some embodiments, some of the subscriber domain details are provided by the registered players. Media request transactions between a DRM license server and a client device associated with a subscriber domain are recorded.

Other features as described herein will be apparent from the accompanying drawings and from the detailed description which follows.

### BRIEF DESCRIPTION OF DRAWINGS

The embodiments as described herein are illustrated by way of example and not limitation in the figures of the accompanying drawings in which like references indicate similar elements.

FIG. 1 shows a block diagram illustrating an exemplary embodiment of a domain manager network.

FIG. 2A shows an exemplary embodiment of the domain association.

FIG. 2B shows an exemplary embodiment of the device type identification.

FIG. 2C shows an exemplary embodiment of the content distribution path determination.

FIG. 2D shows an exemplary embodiment of the catalog adjustment.

FIG. 2E shows an exemplary embodiment of the device registration.

FIG. 2F shows an exemplary embodiment of the DRM license authorization.

FIG. 2G shows an exemplary embodiment of the domain monitoring.

FIG. 3 is a diagram illustrating an exemplary embodiment of a system to provide an adjusted domain catalog.

FIG. 4 is a block diagram illustrating an exemplary embodiment of a subscriber domain.

FIG. 5 is a diagram illustrating an exemplary embodiment of a system to authorize a subscriber device to access media content for a subscriber domain.

FIG. 6 is a diagram illustrating an exemplary embodiment of a system to provide identification, registration, entitlement and asset rule verifications.

FIG. 7 is a diagram illustrating an exemplary embodiment of a system to provide domain analytics.

FIG. 8 is a block diagram illustrating an alternate embodiment of a system for providing, authorizing and monitoring the distribution of multimedia content, within a subscriber domain of devices.

FIG. 9 is a transaction diagram illustrating one embodiment of a method to provide a domain discovery.

FIG. 10 is a transaction diagram illustrating one embodiment of a method to provide a domain registration.

FIG. 11 is a transaction diagram illustrating an exemplary embodiment of a method to resume a paused session.

FIG. 12 is a transaction diagram illustrating an exemplary embodiment of a method to resume a paused session to another player from the original gateway.

FIG. 13 is a transaction diagram illustrating an exemplary embodiment of a method to resume a paused session to a current player from an alternate gateway.

FIG. 14 is a transaction diagram illustrating an exemplary embodiment of a method to resume a paused session to another player from an alternate gateway.

FIG. 15 is a table illustrating an exemplary embodiment of resuming delivering an asset.

FIG. 16 is a table illustrating another exemplary embodiment of resuming delivering an asset.

FIG. 17 is a table illustrating yet another exemplary embodiment of resuming delivering an asset.

FIG. 18 is a diagram illustrating one exemplary embodiment of a data structure containing subscriber domain monitoring data.

FIG. 19 illustrates an exemplary embodiment of a database to enable domain management.

FIG. 20 illustrates an exemplary embodiment of a graphical user interface that uses the recorded media distribution within a subscriber domain of devices activities for domain analytics.

FIG. 21 shows a flowchart of an exemplary embodiment of a method to manage a subscriber domain that can be performed at a domain manager server.

FIG. 22 shows a flowchart of an exemplary embodiment of a method at a domain manager server to provide an adjusted catalog.

FIG. 23 shows a flowchart of an exemplary embodiment of a method to register a client device within a subscriber domain.

FIG. 24 shows a flowchart of an exemplary embodiment of a method to authorize a DRM license server request.

FIG. 25 shows a flowchart of an exemplary embodiment of a method at a domain gateway to manage media content.

FIG. 26 shows a flowchart of an exemplary embodiment of a method at a subscriber device to manage media content.

FIG. 27 shows a block diagram of one embodiment of a data processing system to provide domain management.

### DETAILED DESCRIPTION

The embodiments will be described with references to numerous details set forth below, and the accompanying drawings. The following description and drawings are illustrative of the embodiments and are not to be construed as limiting. Numerous specific details are described to provide a thorough understanding of the embodiments as described herein. However, in certain instances, well known or conventional details are not described in order to not unnecessarily obscure the embodiments in detail.

Reference throughout the specification to “at least some embodiments”, “another embodiment”, or “an embodiment” means that a particular feature, structure, or characteristic described in connection with the embodiment is included in at least some embodiments as described herein. Thus, the appearance of the phrases “in at least some embodiments” or “in an embodiment” in various places throughout the specification are not necessarily all referring to the same embodiment. Furthermore, the particular features, structures, or characteristics may be combined in any suitable manner in one or more embodiments.

Exemplary embodiments of methods and apparatuses for domain management are described. In at least some embodiments, the objective of domain management is to provide, authorize and monitor the distribution of subscriber-entitled assets, from the applicable gateways and gateway content distribution paths, to registered subscriber devices without requiring any specific software cooperation with the gateways and the subscriber devices.

At least one embodiment as described herein, defines a method for distributing premium video content within a subscriber domain of devices. In one embodiment, a subscriber domain comprises an association of a) one or more gateways, b) one or more entitlements, c) one or more domain rights applicable to the subscriber domain and d) a set of registered player devices. In one embodiment, a domain is associated with a subscriber. In one embodiment, multiple subscribers are associated with multiple domains.

In at least some embodiments, an asset can be, but is not limited to a movie, a TV series episode, a documentary, a song, an application or a game, and can be made available as a stream or a file to download. Streamed assets can be linear (e.g. live TV channel) or on demand (e.g. VOD catalog). Access to download asset can be temporary (e.g. rental) or permanent (e.g. purchase).

In addition, at least one embodiment introduces service provider defined behaviors for the domain, such as a) player profiles that recommend a set of audio, video, streaming and download protocol parameters per subscriber device type, b) domain rules that limit the number of subscriber devices that can be registered to a domain, and c) asset rules that restrict the distribution of asset categories to approved DRM clients.

In at least some embodiments, playback of all past and current domain playback sessions can be resumed across multiple players registered within the domain.

In at least one embodiment, the gateway content distribution paths includes a broadcast legacy distribution network (e.g. cable or satellite), a transparent Internet Protocol based distribution network (e.g. Internet Protocol (IP) VOD over a cable or telco network), an opaque Internet Protocol based distribution network (e.g. Over-the-top Amazon “Cloudfront” or Akamai “Akamai HD Network”), a private home network, or a combination thereof.

The embodiments as described herein improve the user experience by dynamically feeding the application server with a fully integrated, synthetic and dynamic view of what assets can be played back and how they can be played back in the context of a given player connection within a domain.

The embodiments as described herein improve the authorization process by managing devices regardless of technology or DRM capabilities, managing assets with different distribution rules, and managing domains with different entitlement rights.

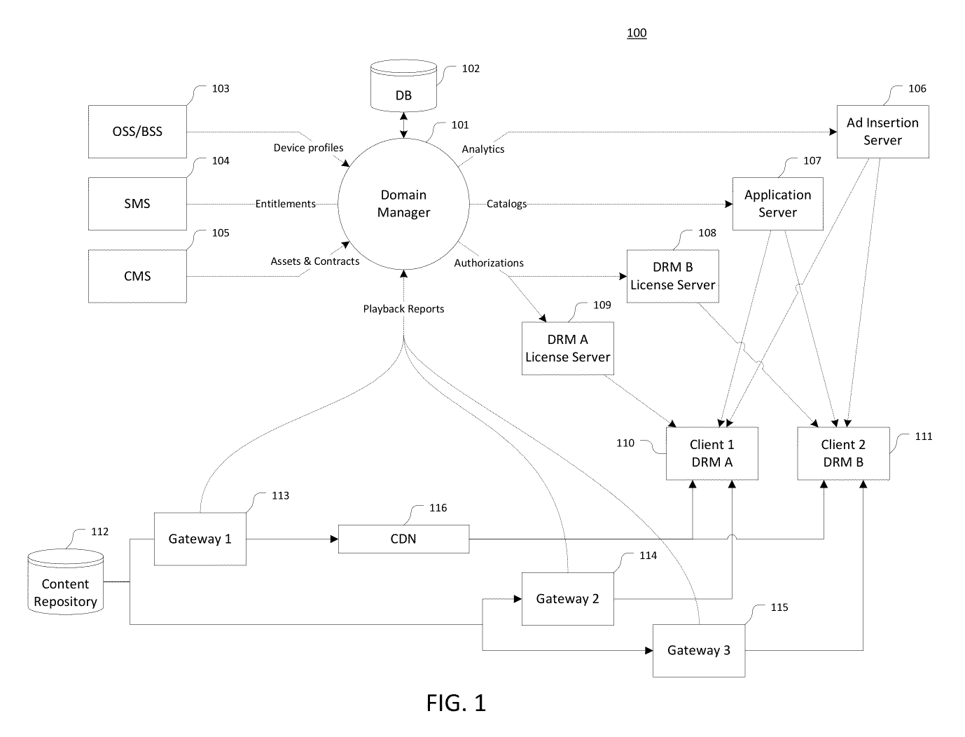

FIG. 1 shows a block diagram illustrating an exemplary embodiment of a domain manager network 100. As shown in FIG. 1, a domain manager (DM) server 101 is coupled to a database (DB) 102, an operation support system/business support system (OSS/BSS) 103, a subscriber management system (SMS) 104, a content management system (CMS) 105, an advertisement (ad) insertion server 106, an application server 107, a DRM B license server 108, and DRM A license server 109, a gateway 113, a gateway 114, and a gateway 115 (e.g., via corresponding network connections). As shown in FIG. 1, OSS/BSS 103 provides device profile data, SMS 104 provides entitlements data and CMS 105 provides assets and contracts data. DM 101 provides catalog data to application server 107, authorization data to DRM license servers 108 and 109, and analytics data to ad insertion server 106.

In at least some embodiments, a subscriber domain can include different types of client devices that are made using different technologies. For example, a client 110 can be an iPad, or Android tablet, and a client 111 can be a television with a network connection (“smart” TV), or a personal computer, for example a PC, or Mac. The subscriber devices can be secured with different Digital Rights Management (“DRM”) systems. For example, client 110 can be secured by a DRM A, and subscriber device 111 can be secured by a DRM B.

As shown in FIG. 1, client 1 110 is connected to a network gateway 113 via a CDN 116, and a home gateway 114. Client 2 111 is connected to the same network gateway 113 using the same CDN 116, but a different home gateway 3 115. All gateways are directly or indirectly coupled to a content repository 112 that includes all the referenced assets provided by the operator. The home gateway access the content repository 112 through a private interface. As shown in FIG. 1, each of the gateways 113, 114, and 115 sends playback reports to DM 101. Client 111 is coupled to a gateway 3 115 via a local IP network, while at home, and via Internet while roaming, providing that GW3 115 has a public IP address. As shown in FIG. 1, each of the clients 110 and 111 can be coupled to application server 107. In one embodiment, the application server contains an on-line application to browse media content. Systems and methods for navigating broadcast signals using an on-line navigation application are described in a U.S. patent application Ser. No. 12/228,665 entitled “DISTRIBUTED TV ACCESS SYSTEM” which is incorporated herein by reference in its entirety.

In at least some embodiments, the application server sends a request to the DM server to get an adjusted domain catalog for the subscriber device. An adjusted domain catalog is described in further detail below. In at least some embodiments, a database (“DB”) coupled to the DM server, such as DB 102 stores information associated with the subscriber domains (e.g., data identifying the subscriber devices, playback positions, and other subscriber domain information). In at least some embodiments, a web application (not shown) coupled to the DM server and facing a service provider allows configuring, monitoring and analyzing the domain management activities, as described herein.

In at least some embodiments, DM 101 is a Maelstrom™ Domain Manager (MDM) server produced by Digital Keystone Inc., located in Mountain View, Calif.

In at least one embodiment, the DM server is designed to be scalable, and to integrate with the existing operator backend infrastructure. In at least some embodiments, the DM server includes one or more web services incorporating embodiments of methods as described herein to communicate with a OSS/BSS 103, a SMS 104, a CMS 105, a DRM License Servers 108 and 109, an application Server 107 and an ad-insertion Server 106.

The home gateway (e.g. gateway 114, and gateway 115) can receive media content from for example, a cable, satellite, terrestrial, or an IPTV legacy CDN, and can be coupled to a storage (not shown) to store a multimedia content. The network gateway (e.g. gateway 113) can directly access one or more content repositories (e.g. origin server). In at least some embodiments, a local IP network of the subscriber device is connected to a global IP network (e.g., Internet) through a router device (not shown).

In at least some embodiments, the subscriber devices 110 and 111 can include a player, which may be a software plug-in, an hardware decoder or the combination of both, for example, a Windows media player, a Flash media player, an iPod, a QuickTime media player, a RealTime media player, or any other video and/or audio player. The subscriber device can include an application program provided by the service provider or a browser to communicate with the application server 107.

In at least some embodiments, the application server in conjunction with the application program or the subscriber device browser, is configured to present a selection of media content to a user, for example, to find what to watch and to start playing the content. In at least some embodiments, the application server is further configured to receive playback control commands from a user, e.g., “play”, “fast forward”, “fast backward”, “jump”, “pause”, and the like, and to decide if that command needs to be sent to the player locally or needs to be sent to the gateway.

In at least some embodiments, the DM server is configured to provide one or more of the following: domain association, device type identification, content distribution path determination, device registration, catalog adjustment, DRM license authorization, and domain monitoring, as described in further detail below.

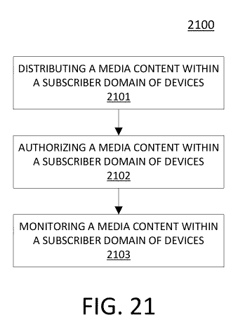

FIG. 21 shows a flowchart of an exemplary embodiment of a method 2100 to manage a subscriber domain that can be performed at a domain manager server, such as DM 101. As shown in FIG. 21, operation 2101 involves distributing media content within a subscriber domain of devices. In at least some embodiments, distributing media content within a subscriber domain of devices involves providing an adjusted catalog, as described in further detail below.

Operation 2102 involves authorizing media content within a subscriber domain of devices. In at least some embodiments, authorizing media content within a subscriber domain of devices involves, as described in further detail below receiving a request from a DRM license server and responding based on the state of the domain and the data carried in the request, as described in further detail below.

Operation 2103 involves monitoring media content within a subscriber domain of devices. In at least some embodiments, monitoring the media content consumption within a subscriber domain of devices involves recording all the requests from the DRM license servers and the playback state transition of the subscriber devices as reported by the gateways, as described in further detail below.

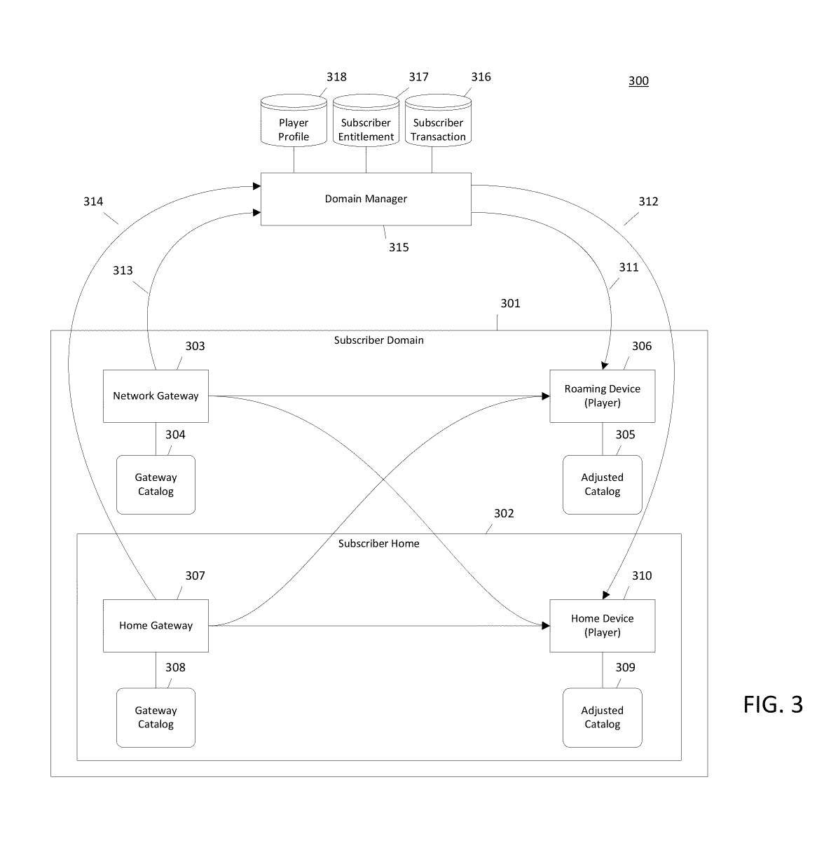

FIG. 3 is a diagram illustrating an exemplary embodiment of a system to provide a domain catalog. As shown in FIG. 3, a subscriber domain 301 comprises a network gateway 303 associated with a gateway catalog 304, a roaming device (player) 306 associated with an adjusted catalog 305, and a subscriber home 302 including a local content source (gateway) 307 associated with a gateway catalog 308, and a home device (player) 310 associated with an adjusted catalog 309. As shown in FIG. 3, a domain manager 315 obtains a gateway catalog 304 from gateway 303 via a network connection 313, and a gateway catalog 308 from gateway 307 via a network connection 314.

As shown in FIG. 3, domain manager 315 stores player profiles 318, subscriber entitlements 317, and subscriber transactions 316 in one or more databases. A subscriber device (e.g., player 306 or player 310) is provided by a domain manager 315 with an adjusted catalog (e.g., adjusted catalog 305 or adjusted catalog 309) unique per connection (e.g., a connection 311 or a connection 312). The adjusted catalogs are depending on the domain association, device type identification, and content distribution path identification results. For example, an adjusted catalog may include a list of generally available assets, based on domain player location and domain gateway catalog and availability, a list of all the assets within the generally available assets that the domain is entitled to play based on domain entitlement rules; the best recommended audio, video, streaming and file download format for each asset in the domain, as set by the profile rule; an asset playback resume position, created by previous paused or interrupted playback sessions in the domain, independently of player and gateway. In at least one embodiment, the adjusted catalog is updated after each of the following domain events: an asset is created, updated or removed for the domain; a gateway is discovered, updated or removed for a player connection; and a playback resume position is created, updated or removed for an asset in the domain.

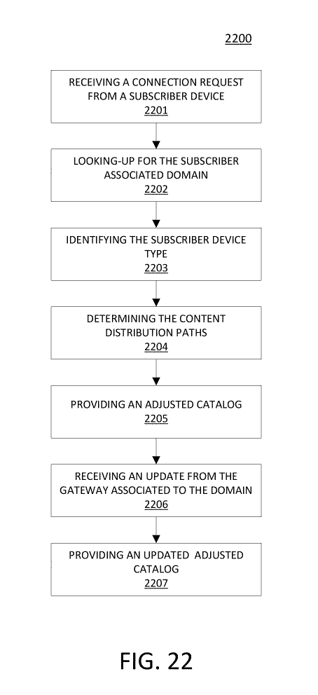

FIG. 22 shows a flowchart of an exemplary embodiment of a method 2200 at a DM server to provide an adjusted catalog. Method 2200 begins with operation 2201 that involves receiving a connection request from a subscriber device. In at least some embodiments, the request is received from an application server, e.g., application server 107. In at least some embodiments, the request is received directly from a subscriber device (e.g., client device 110, 111, 306, or 310). At operation 2202, the domain associated to the subscriber is looked up. At operation 2203 the subscriber device type is identified. At operation 2204, the valid content distribution paths for the connection are determined. At operation 2205, an adjusted catalog for the connection is provided. Optionally, at operation 2206, a change to the gateway associated to the domain is detected and an updated adjusted catalog is provided at operation 2207.

### Domain Association

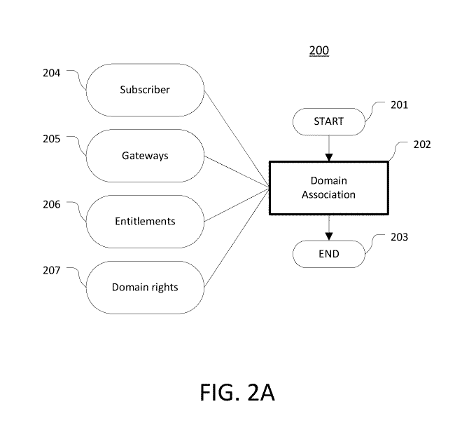

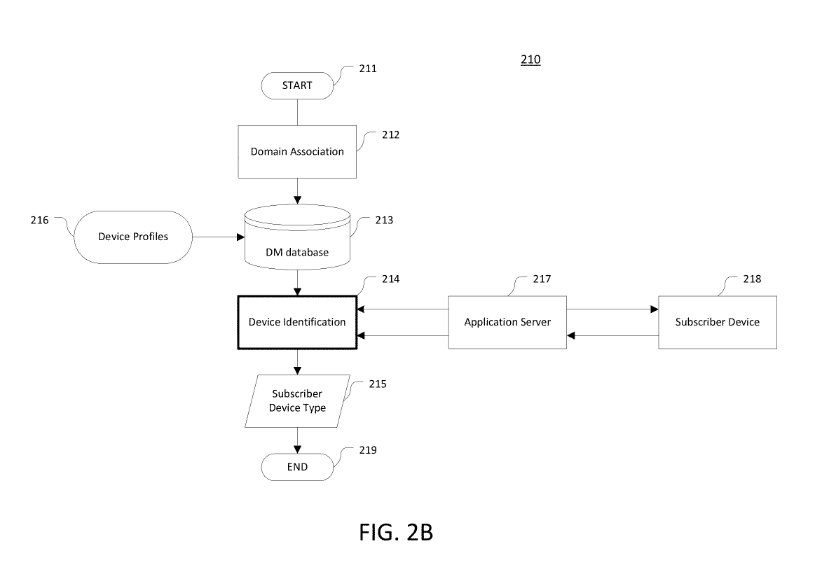

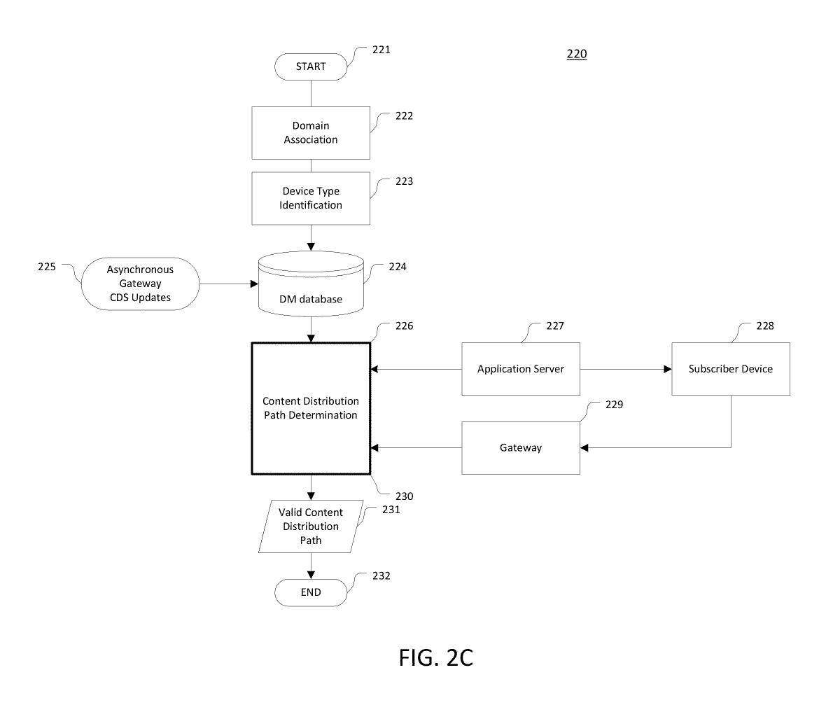

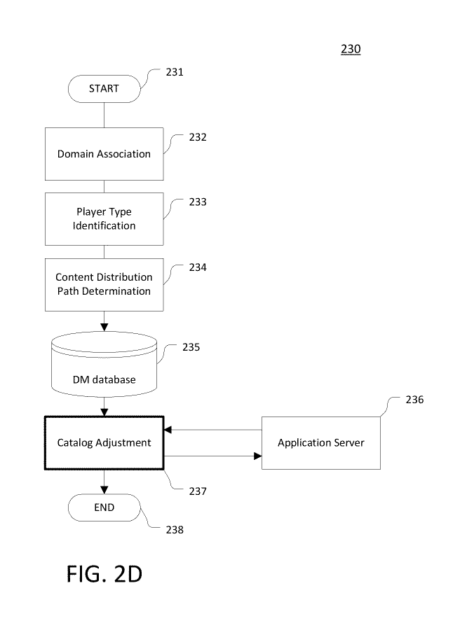

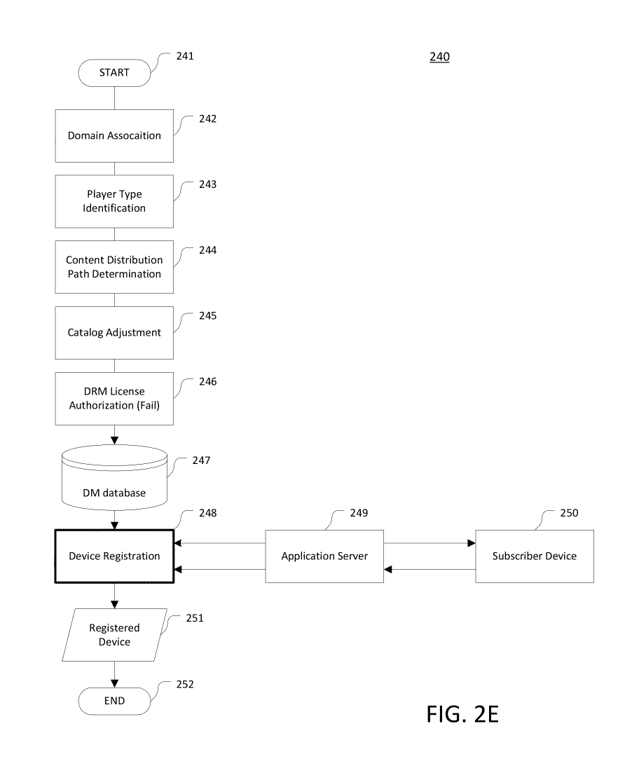

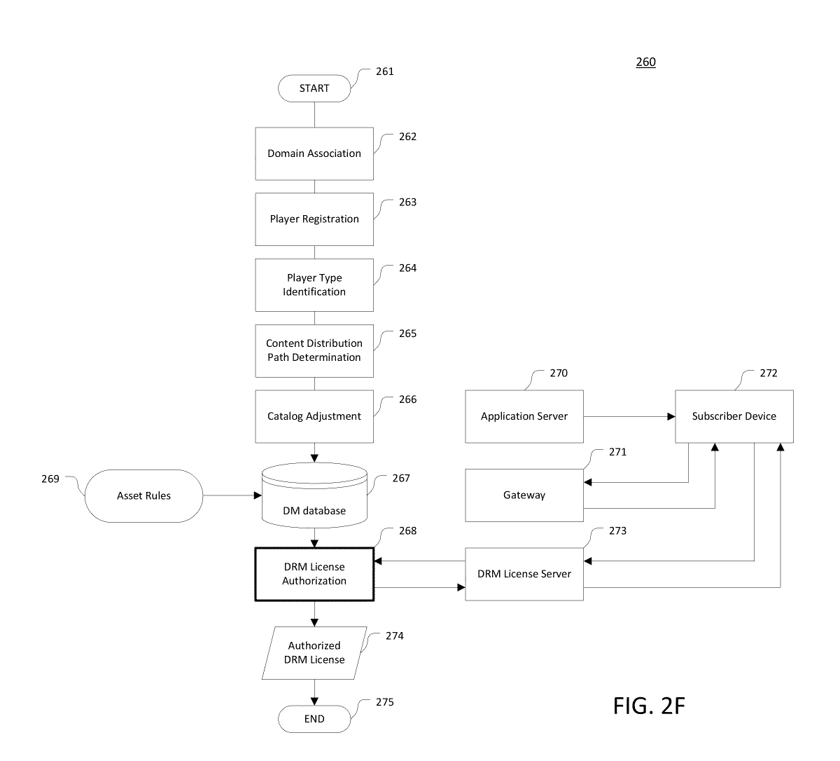

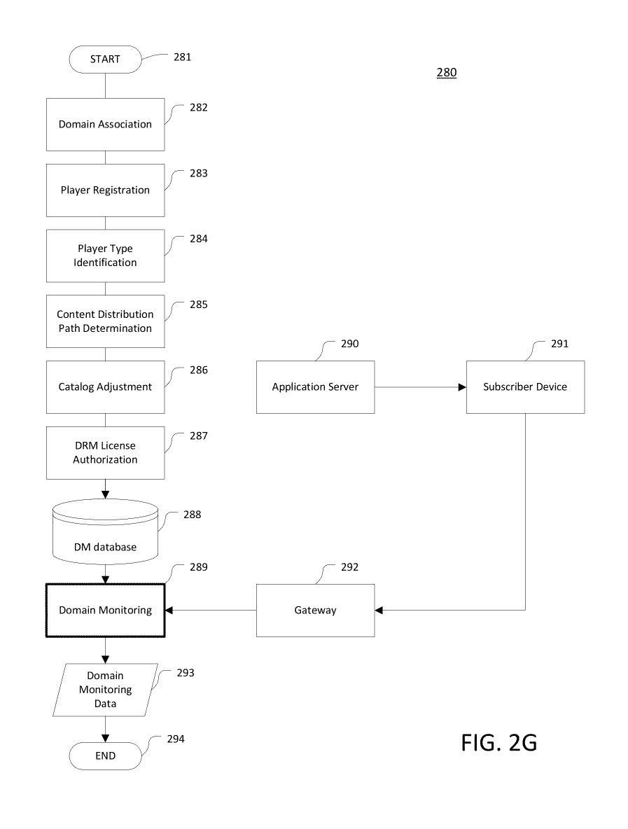

FIG. 2A shows an exemplary embodiment of the domain association. A domain association 200 starts at a block 201. At a block 202 one or more subscriber devices 204, one or more gateways 205, one or more entitlements 206 and one or more domain rights 207 are associated into a subscriber domain. In at least one embodiment, domain association data are stored in a DM database (not shown). Domain association 200 ends at a block 203.

### Device Type Identification

FIG. 2B shows an exemplary embodiment of the device type identification. A device type identification 210 starts at a block 211. Domain association data 212 and device profiles data 216 are stored in a DM database 213. Upon connection with a subscriber device 218, an application server 217 is provided by the DM server with an executable code (e.g., a JavaScript file) that needs to be run on subscriber device 218. The executable code returns the data resulting from running the executable code on subscriber device 218 to the DM via application server 217. In at least some embodiments, the extracted data includes the type, major version, minor version and build number of the platform, browser and plugin of the subscriber device. These data are compared by the DM against exiting device profiles 216 stored in database 213 and a type of a subscriber device 215 is identified at a block 214. Device type identification 210 ends at a block 219.

In at least one embodiment, a discovery of the active content distribution paths to the gateways by the subscriber device is performed, as described herein.

### Content Distribution Path Determination

FIG. 2C shows an exemplary embodiment of the content distribution path determination. A content distribution path determination 221 starts at a block 221. As shown in FIG. 2C, domain association data 222, device type identification data 223 and asynchronous gateway content directory service (CDS) updates data 225 are stored in DM database 224. That is, after domain association, gateways can upload asynchronously their catalog data to the DM. The gateway catalog data include the gateway content distribution path identifiers (e.g. URLs or IP addresses), and the list of assets and format that the gateway can provided. The gateway catalog data are stored in DM database 224. Upon connection with a subscriber device 228, DM provides a list of all the domain gateway content distribution path identifiers to an application server 227, which passes them to the subscriber device 228. In one embodiment, one or more content distribution paths to the associated gateways are determined at a block 226 by verifying that the gateway content distribution path identifiers are reachable by the subscriber device. When a gateway 229 is reached by a subscriber device 228, gateway 229 sends a report to DM. At a block 231 the content distribution path is validated based on the report from gateway 229. Content distribution path determination ends at a block 232.

In at least some embodiment, determining one or more content distribution paths to the associated gateways for the subscriber device also involves localizing the subscriber device by the gateways, identifying the presence of an edge-caching server interface, or a combination thereof.

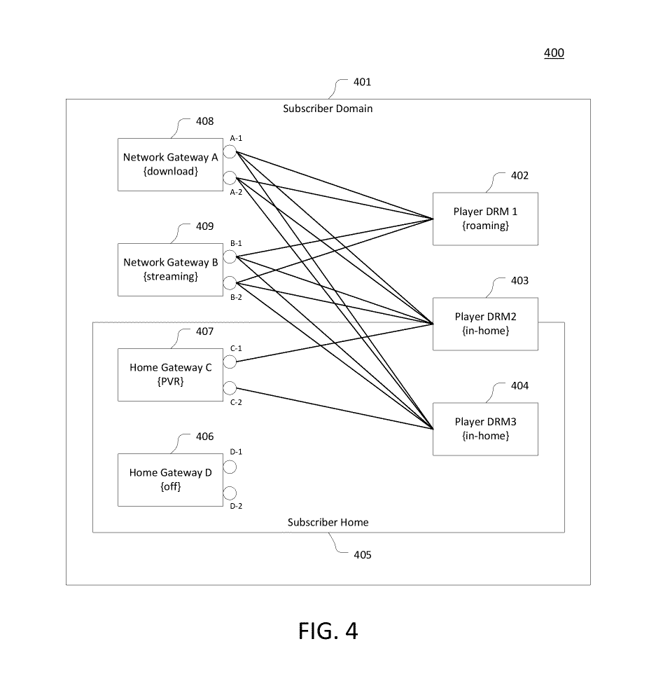

FIG. 4 is a block diagram 400 illustrating an exemplary embodiment of a determination of content distribution paths within a subscriber domain. As shown in FIG. 4, a subscriber domain 401 includes two home gateways, such as gateways 406 and 407 and two network gateways, such as gateways 408 and 409. The content distribution path determination method detects that gateway 406 is not reachable on any of its interface (e.g. turned off); a player 402 is roaming and can reach both network gateways on both of their interfaces, but cannot reach home gateway 407; a player 403 is at home and can reach both network gateways on both of their interfaces and home gateway 407 on one physical interface (e.g. Ethernet); a player 404 is also at home and can reach both network gateways on both of their interfaces and home gateway 407 on another physical interface (e.g. Wi-Fi). The content distribution path determination is a pre-requisite to the generation of an adjusted catalog.

### Catalog Adjustment

Referring back to FIG. 22, at operation 2204 an adjusted catalog (e.g., one of catalogs 305 and 309) is generated for the subscriber device based on the device type. At operation 2205 an update associated with the subscriber domain is received. In at least some embodiments, the update a change involving at least one of the gateways associated to the domain. At operation 2206 the adjusted catalog is modified based on the update. At operation 2207 the newly adjusted catalog is sent to the subscriber device (e.g., one of the players 306 and 310).

FIG. 2D shows an exemplary embodiment of the catalog adjustment. A catalog adjustment 230 starts at a block 231. As shown in FIG. 2D, domain association data 232, player type identification data 233, and content distribution path determination data are stored in DM database 235. That is, domain association, player type identification and content path determination are prerequisites to adjust a domain catalog. Catalog is requested by an application server 236. In response, the domain catalog is adjusted at a block 237 based at least on one of the domain association data, player type identification data, and content distribution path determination data, as described in further detail below. The adjusted catalog is delivered to the application server. Catalog adjustment ends at a block 238.

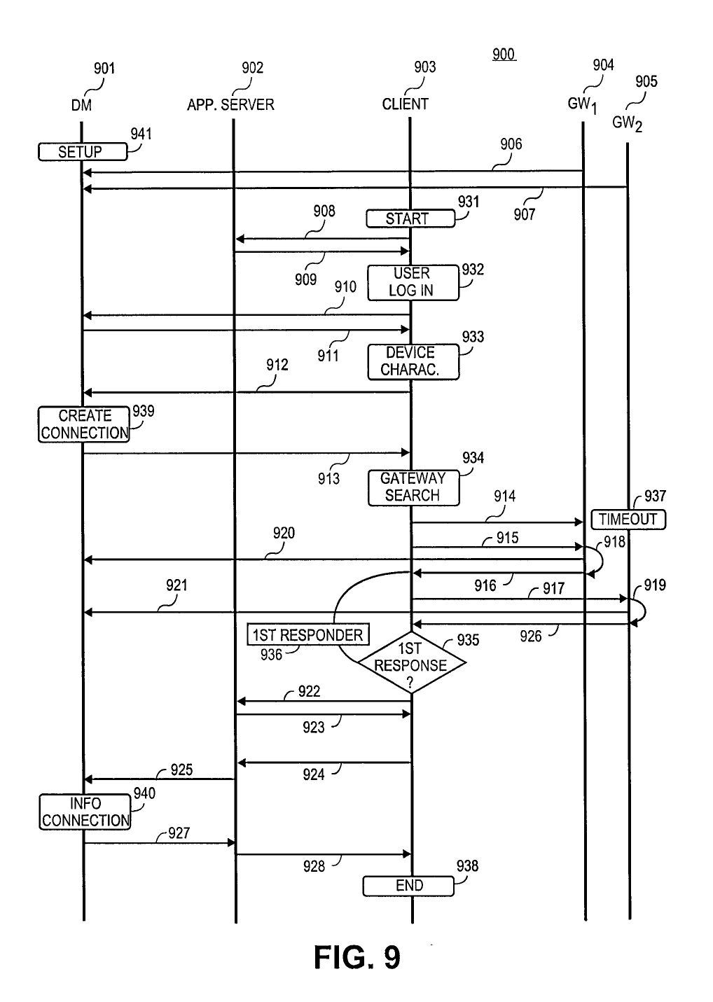

FIG. 9 is a transaction diagram 900 illustrating one embodiment of a method to perform content distribution path determination. As shown in FIG. 9, a SET UP 941 refers to automatically posting by gateways 904 and 905 new data at 906 and at 907 respectively to a DM 901 when their catalogs or addresses change. These transactions are happening in the background and are not synchronized with subscriber device activities. A START 931 refers to providing a login page of an application server 902 at 909 in response to a user request at 908.

A USER LOG IN 932 refers to requesting a user at subscriber device (client) 903 to enter her username and password, and requesting at 910 the creation of a new connection by the DM 901, using the received credentials. The DM 901 acknowledges and returns at 911 an executable code (e.g., a JavaScript file) that needs to be run on the subscriber device 903. In one embodiment, the user credentials are unique to a domain; in some other they are unique per user of the domain.

A DEVICE TYPE IDENTIFICATION 933 refers to executing the code providing at 911 on the subscriber device and returning the output result back to DM at 912. In one embodiment, the output result consists of an identifier unique to the characteristics of the platform, browser and plugin of the subscriber device.

CREATE CONNECTION 939 refers to creating in the DM 901 database a connection for the domain based on the identified subscriber device type value, a connection data is returned to the subscriber device by DM 901 at 913. In one embodiment, the connection data provided by the DM includes a list of all the domain gateway content distribution path identifiers (e.g. URLs and IP addresses).

A CONTENT DISTRIBUTION PATH DETERMINATION 934 refers to the client 903 querying all the domain gateway content distribution path identifiers at 914, 915, 917. Queries that manage to reach a gateway are echoed back to DM 901 at 920 and 921. FIG. 9 shows another request 914 that is not responded before a timeout 937. Client 903 looks at 935 for a first valid response 936 provided at 916 from gateway 904 to request application server 902 a navigation page at 922, and receives the navigation page from the application server 902 at 923. As shown in FIG. 9, another valid response is provided from a gateway 905 at 926.

A CONNECTION INFO 940 refers to requesting the application server 902 for a connection information update at 924. Application server 902 sends a request for the connection information update to DM 901. DM 901 sends the connection information to application server 902 at 927. Application server 902 sends the connection information to client 903 at 938. The connection information includes an adjusted catalog that only includes the assets of the reachable domain gateways with a protocol and a format compatible with the identified subscriber type and a unique locator (e.g. URLs or IP addresses) that is compatible with the determined content distribution paths.

In one embodiment, the adjusted catalog is further filtered based on application parameters such as an asset category, a specific asset, a subscribed asset, or any combination thereof.

In one embodiment, the connection information response includes a hash value, which can be added in the following connection information requests to allow the DM 901, not to generate another adjusted catalog if no change has been detected. In one embodiment, the connection information changes if one or more of the following event has occurred: one of the participating domain gateways has added or removed titles; one of the participating domain gateways has changed its IP addresses; one of the domain gateways has dropped off the connection; and one of the domain gateways has joined the connection.

### Device Registration

In at least some embodiments, upon initial play request, each subscriber device is requested to register with the DM. FIG. 2E shows an exemplary embodiment of the device registration. A device registration 240 starts at a block 241. As shown in FIG. 2E, at least one of domain association data 242, player type identification data 243, content distribution path determination data 244, catalog adjustment data 245, and failed DRM license authorization data are stored in a DM database 247. As shown in FIG. 2E, domain association, player type identification, content path determination, catalog adjustment, and a failed DRM license authorization are prerequisites to a device registration. Upon a failure of the DRM license authorization, an application server 249 discovers a registration error, and proposes a user to register a subscriber device 250. A device registration is performed at a block 248 upon request by the application server based on the DRM identity of the subscriber device as verified and recorded during the failed DRM license authorization and pending that the registration transaction remains within the limit set by the domain rights associated with the device. In some implementation the domain rights limit the maximum number of device that can be registered to a domain, in some other the domain rights requires that the device must be in proximity of one of the home gateway for acknowledging a registration request. Device is registered with a domain at a block 251. In one embodiment, device registration data are stored in a DM database. Device registration ends at a block 252.

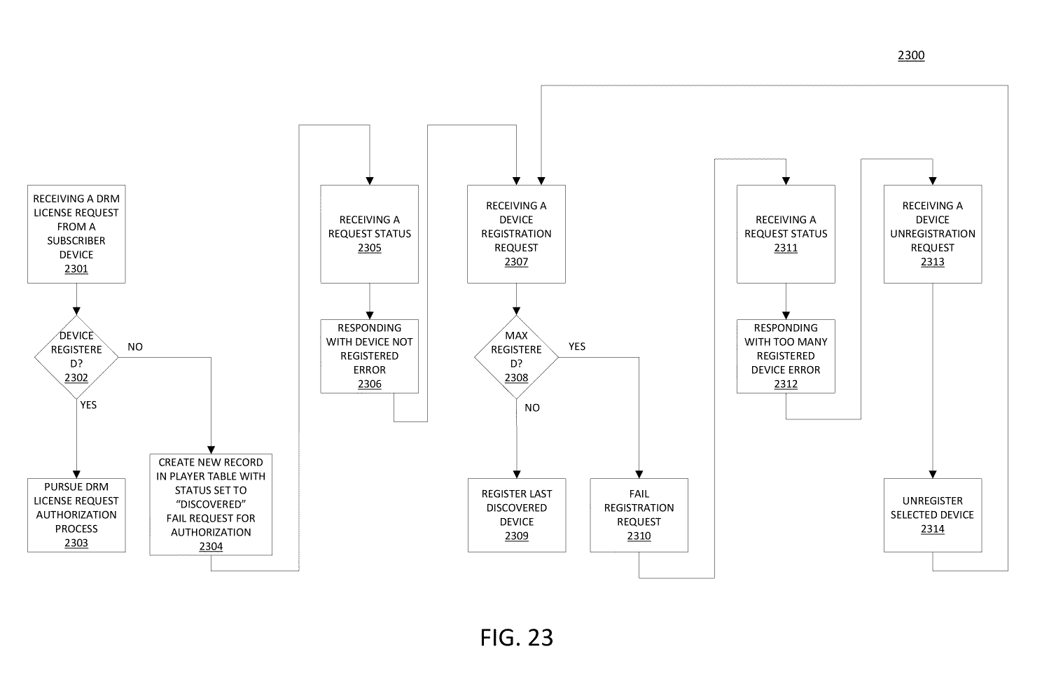

FIG. 23 shows a flowchart of an exemplary embodiment of a method 2300 to register a client device within a subscriber domain. At operation 2301 a license authorization request in behalf of a subscriber device is received from a DRM License server. At operation 2302 it is determined if the DRM identity of the requesting device corresponds to the identity of one of the registered device for the domain. If the subscriber device is not registered, the license request is denied, but the DRM identity of the new subscriber device is recorded in the DM database at operation 2303 with a “discovered” status. If the subscriber device is already registered, the process of license request authorization continues at operation 2303.

In some implementations, the DM receives a status request at operation 2305 after it fails a license request authorization. The DM responds with a “Device Not Registered” error at operation 2306.

In some implementation, the DM receives a registration request at operation 2307 after it reported a registration error. The DM verifies at operation 2308 that the registration of a new device will not increase the domain size over the limit set by the domain rule.

If the maximum limit is already reached, the DM fails the registration request at operation 2310; otherwise the device is added to the subscriber domain at operation 2309.

In some implementation, the DM receives a status request at operation 2311 after it fails a device registration request. The DM responds with a “Maximum Player Exceeded” error at operation 2312.

In some implementation, the DM receives a device unregistration request at operation 2311 after it fails a device registration because of the number of players. The DM unregisters the selected device at operation 2314. In some implementation, the DM receives a second request for device registration at operation 2305 after the “Maximum Player Exceeded” error has been resolved.

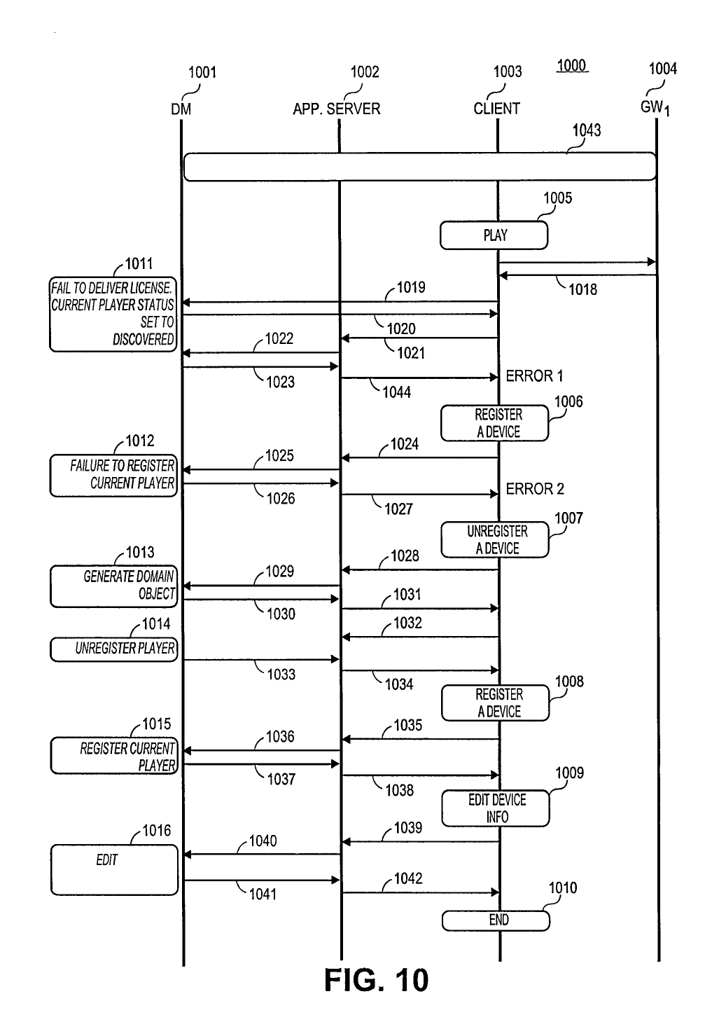

FIG. 10 is a transaction diagram 1000 illustrating one embodiment of a method to provide a domain registration. DOMAIN DISCOVERY 1043 as the successive validation of domain association, device type identification, content path determination and adjusted catalog delivery is a prerequisite, as described above.

PLAY ASSET 1005 refers to sending a request for an asset from a subscriber device CLIENT 1003 to a gateway GW 1004 at a transaction 1017, and receiving the asset from GW 1004 at a transaction 1018. At a transaction 1019, CLIENT 1003 has detected that the asset is encrypted and initiates a DRM license request to DM 1001, as instructed in the playlist/manifest. In this representation, the DRM License Server has been combined with the DM 1001. The DM 1001 determines that CLIENT 1003 is an unregistered player, and denies the authorization at a transaction 1020. However, DM 1001 adds the subscriber device 1003 to the domain with a “DISCOVERED” status at a transaction 1011. In one embodiment, depending on a type of a player, the custom license request error code may not be supported, and the application server is recommended to call DM to get a DM error code. As shown in FIG. 10, CLIENT 1003 requests at a transaction 1021, application server 1002 to get an error code. At a transaction 1022 application server 1002 requests DM 1001 for an error code. At a transaction 1023, an error 1 “Player Not Registered” is delivered to Application server 1002 that sends the error 1 to CLIENT 1003, at a transaction 1044.

REGISTER CURRENT DEVICE 1006 refers to sending a request to register CLIENT 1003 to application server 1002 at a transaction 1024. The application server 1002 requests the registration by calling the DM 1001 at a transaction 1025. In this case, DM 1001 fails to register CLIENT 1003 and sends an error 2 “Number Player Exceeded” at a transaction 1026. Error 2 is forwarded to client 1003 by application server 1002 at a transaction 1027. In one embodiment, after receiving error 2, the application sends a request to unregister an older device.

UNREGISTER DEVICE 1007 refers to sending from a client 1003 a request to application server 1002 at a transaction 1028, application server 1002 calls DM 1001 at a transaction 1029 to get an inventory of all the registered players, which is provided by DM 1001 at operation 1030, and forwarded to CLIENT 1003 at operation 1031. Each device is uniquely identified by its DRM identity. In response, CLIENT 1003 requests to unregister one of the registered device at a transaction 1032, DM 1001 unregisters the selected device to application server 1002 at a transaction 1014, sends a confirmation to application server 1002 at a transaction 1033, which is forwarded to CLIENT 1003 at a transaction 1034.

REGISTER CURRENT DEVICE 1008 refers to sending from application server 1002 another request to register CLIENT 1003 to DM 1001 at a transaction 1036 in response to a request from a client 1003 at a transaction 1035. DM 1001 registers the current player device at a transaction 1015, and confirms successful registration to application server 1002 at a transaction 1037. Application server 1002 transmits this confirmation to CLIENT 1003 at a transaction 1038.

EDIT DEVICE INFO 1016 refers to sending a request from CLIENT 1003 to rename a registered device at a transaction 1039 to application server 1002. The application server 1002 calls the DM to for example rename the current device to “myiPad” at a transaction 1040. DM 1001 edits the information about the current player device at a transaction 1015, and confirms successful editing to application server 1002 at a transaction 1041. Application server 1002 transmits this confirmation to client 1003 at a transaction 1042.

### DRM License Authorization

FIG. 2F shows an exemplary embodiment of the DRM license authorization. A DRM license authorization 260 starts at a block 261. As shown in FIG. 2F, domain association data 262, player registration data 263, player type identification data 264, content distribution path determination data 265, catalog adjustment data 266, and asset rules data 269 are stored in a DM database 267. That is, domain association, player registration, player type identification, content distribution path determination services are prerequisites for the DRM license server authorization. Upon asset selection, a subscriber device 272 coupled to an application server 270 sends a request to a gateway 271, and receives an asset from gateway 271. If the received asset is encrypted, subscriber device 272 sends a request for a license to a DRM license server 273.

The license server sends a request for a DRM license authorization to the DM. DRM license authorization is performed at a block 268 based at least on one of the domain association data, player registration data, player type identification data, content distribution path determination data, catalog adjustment data, and asset rules data. In at least one embodiment, the DM determines if all conditions regarding to the domain association data, player registration data, player type identification data, content distribution path determination data, catalog adjustment data, and asset rules data are met for the license authorization, as described in further detail below. If all conditions are met, a DRM license is approved at a block 274. The approved DRM license is sent to DRM license server 273. The DRM license server authorization ends at a block 275.

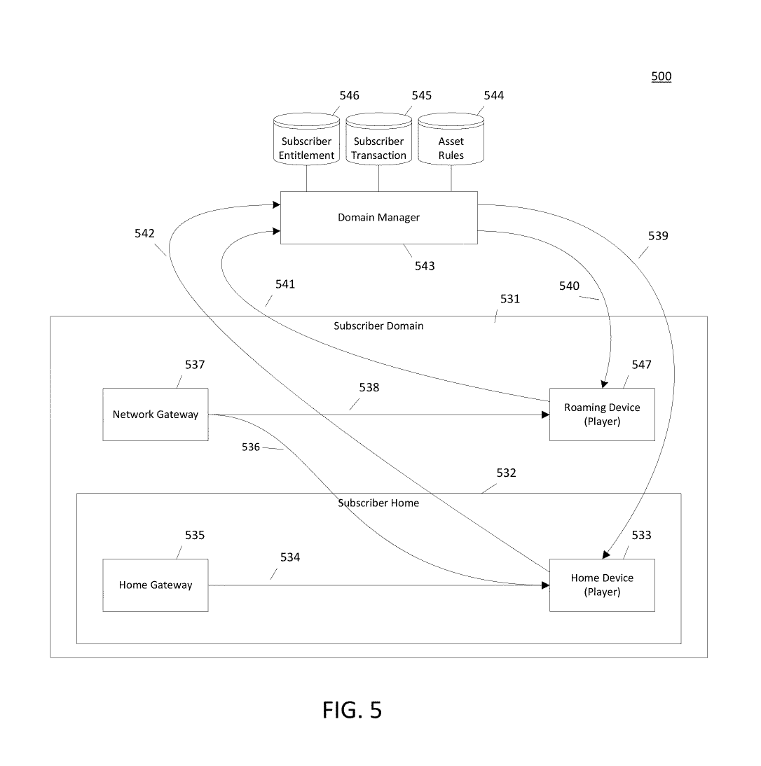

FIG. 5 is a diagram illustrating an exemplary embodiment of a system 500 to authorize a subscriber device to access media content (e.g., an asset) for a subscriber domain. As shown in FIG. 5, subscriber domain 531 comprises a network gateway 537 coupled to a roaming device (player) 547 via a global network connection 538, and a subscriber home 532 including a home gateway 535 coupled to a home device (player) 533 via a local network connection 534. As shown in FIG. 5, player 533 is also coupled to a remote gateway 537 via a global network connection 536. As shown in FIG. 3, a domain manager 543 stores subscriber entitlements 546, subscriber transactions 545, and asset rules 544 in one or more databases. Player 547 sends a request 541, and player 533 sends a request 542 to access the media content to domain manager 543. DM 543 provides an authorization 539 to player 533 and an authorization 540 to player 539 to access the media content after identification, registration, entitlement and asset rule verifications are performed.

The DM enforces multi-dimensional content distribution rules. In at least some embodiments, at least three types of verification are made before releasing licenses to allow content consumption. In at least one embodiments, a transaction associated with a DRM license request is authorized if all of the following conditions are met: a player and a license request are properly authenticated; the player has been registered with a subscriber domain; the subscriber domain is entitled to access the requested asset at the time and location of the connection; and there is a matching asset rule that authorizes asset playback on that player at that location and at that time.

In at least one embodiment, the playback approval is dynamically updated when player approval, domain entitlement, or asset rules are created, updated or removed.

In at least some embodiments, upon content playback request, the DM verifies the integrity of input parameters for example to restrict access only to players that are properly authenticated; and to restrict access only to content that is properly authenticated.

In at least some embodiments, upon content playback request, the DM ensures that the player is properly registered, for example to restrict access only to subscriber devices that are registered in the same domain as the gateways.

In at least some embodiments, upon content playback request, the DM ensures that the domain is entitled to access the requested content at the time of playback. Entitlement verification, for example, allows an operator to define per-domain content entitlements, allows operator to limit entitlement to in-home consumption, restricts access to assets within certain asset classes in the domain (block non-subscribers), restrict access to devices in proximity if of the home gateways (block roaming players), and provides the application with authorization error code.

In at least some embodiments, upon content playback request, the DM ensures that the player is authorized to access the requested content at the time of playback. In at least some embodiments, content access per Digital Rights Management (DRM) for a given time window is defined by the operator according to a content agreement. Content contract verification, for example, allows the operator to define playback rights for an asset-class associated with a contract on a per-approved DRM basis; restricts playback to an approved DRM on a per asset-class basis; restricts playback to an up-to-date DRM on a per asset-class basis; restricts playback to devices in proximity on a per asset-class basis; and provides the application with authorization error/behavior code.

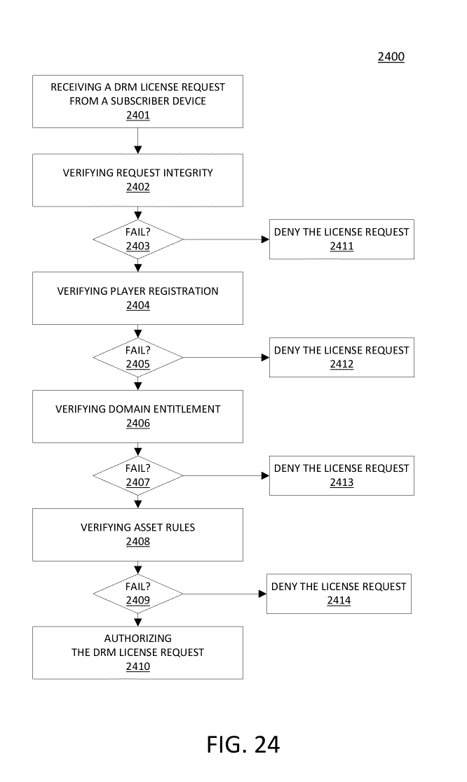

FIG. 24 shows a flowchart of an exemplary embodiment of a method 2400 to provide a DRM license authorization. Method begins with operation 2401 that involves receiving a DRM license request for media content. At operation 2402 the integrity and consistency of parameters (e.g., a player certificate, connection ID, asset ID) is verified.

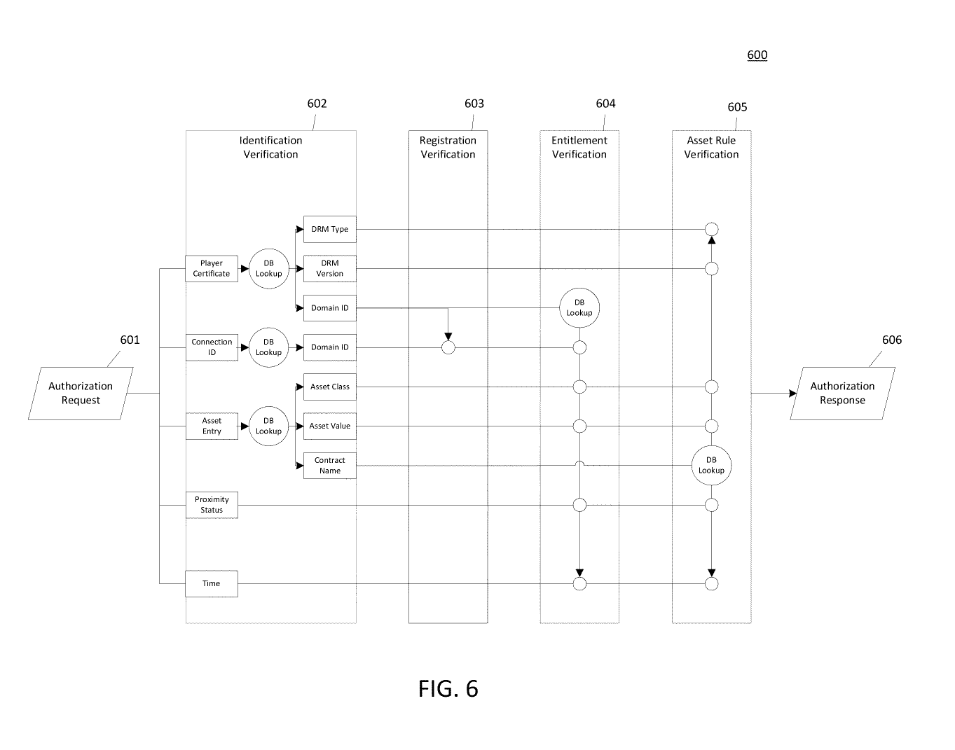

FIG. 6 is a diagram illustrating an exemplary embodiment of a system 600 to provide identification, registration, entitlement and asset rule verifications. As shown in FIG. 6, an authorization request 601 is received by the system 600 from a client device. A player certificate, connection ID, asset ID, contract ID, profile ID, proximity status, and time are derived from the license request. The client device identification verification is performed at 602.

As shown in FIG. 6, a DRM type, a DRM version, and a Domain ID associated with the device certificate are verified to be supported in the DM database. A domain ID is looked in a database based on the connection ID, and an asset class, asset value, and contract name are looked up in the database based on the asset ID, as shown in FIG. 6. That is, DM qualifies, using its database, all the parameters included in the license request 601, as follows:

a player certificate is used to retrieve the DRM type, DRM version and the Domain ID of the domain to which the player has been registered;

a connection ID is used to identify the Domain ID of the gateway;

an asset ID is used to query the content management tables to look-up for the corresponding asset class (for example VOD, Linear, or HBO), asset value (for example EIDR number or channel number) and content contract (i.e. for example view, rent, or own);

a proximity status is in the form True or False;

time is the server time when the license request is submitted.

In one embodiment, any failure to identify these parameters fails the license request.

Referring back to FIG. 24, at operation 2403 it is determined if at least one of the identification parameters fail to be verified. If at least one of the parameters fails to be verified, the license request is denied at operation 2411. If all the identification parameters are verified, the player registration within the subscriber domain is verified at operation 2404. In one embodiment, verifying the device registration involves determining if the registration domain of the device is the same as the domain of the gateway, which provides the content.

Referring back to FIG. 6, registration verification is performed at 603. As shown in FIG. 6, registration verification 603 can be performed by determining if the domain ID associated with the player certificate is the same as the domain ID associated with the connection ID. That is, the DM verifies that the registration domain of the device is the same as the domain of the gateway, which provides the content. In one embodiment, any failure in registration verification fails the license request.

Referring back to FIG. 24, at operation 2405 it is determined if the registration verification fails. If the player registration verification fails, the license request is denied at operation 2412. If the player registration within the domain is verified, method 2400 continues with operation 2406 that involves verifying that the domain is entitled for the selected asset.

Referring back to FIG. 6, a verification of the entitlement for an asset 604 involves verifying the domain ID, asset class, and time for the subscriber domain in the database. That is, the DM verifies that the domain is entitled for the selected asset. This test is performed by looking at all of the domain entitlement records to identify a match with the relevant license request identified parameters. In one embodiment, an asset class is a mandatory parameter and corresponds to an identified service tier. In one embodiment, an asset value is an optional parameter to authorize a per-asset transaction (i.e. VOD). In case of a subscription service the entitlement record should be set to “any”. In one embodiment, a proximity status is an optional qualifier. When set to True in the entitlement record, if forces the asset to be restricted only to player(s) within the subscriber home. In one embodiment, time of the license request is within the entitlement record validity period. In one embodiment the time of the license request is further limited to the play state duration after a first license request for the same asset and within the validity period has been authorized for the same or another domain device (e.g. rental that allows unlimited plays 24 hours after the first play). In one embodiment, any failure in entitlement verification fails the license request.

Referring back to FIG. 24, at operation 2407 it is determined if the entitlement verification fails. If the entitlement verification fails, the license request is denied at operation 2413. If the domain entitlement is verified, method 2400 continues with operation 2406 that involves verifying an asset rule.

Referring back to FIG. 6, a verification of one or more content provider (asset) rules 605 involves verifying at least some of a DRM type, a DRM version, an asset class, an asset value, a contract name, a proximity status, and a time for the subscriber domain in a database. The DM verifies that there is an asset rule that allow the asset to be released on the player DRM system. This test is performed by looking at all of the asset rule records to identify a match with the relevant license request identified parameters. In one embodiment, a DRM type is a mandatory parameter that identified the approved DRM system. In one embodiment, a DRM Version is a mandatory parameter that identified the approved DRM system version. In one embodiment, an asset class is an optional parameter that narrows an asset rule to a class of asset. In one embodiment, an asset value is an optional parameter that narrows an asset rule to a specific asset.

In one embodiment, a contract name is a mandatory parameter that identifies the contract between the operator and the asset distributor. Asset rules are designed to enforce content distribution restrictions within the subscriber domain of such contracts. In one embodiment, a proximity status is an optional qualifier for the asset rule. When set to True in the asset rule record, it forces the asset only to be restricted to device(s) within the subscriber home. In one embodiment, time of the license request is within the asset rule record validity period. In one embodiment, any failure in asset rule verification fails the license request.

Referring back to FIG. 24, at operation 2409 it is determined if the asset rule verification fails. If the asset rule verification fails, the license request is denied at operation 2414. If the asset rule is verified, method 2400 the license request is authorized at operation 2410.

### Domain Distribution Scenarios

In at least some embodiments, the providing of the adjusted catalog enables any paused session to be resumed at any device of the subscriber domain. For example, a paused session between an original gateway and a subscriber device can be resumed within the domain according to four scenarios: with the original gateway and the current device, with an alternate gateway and the current device, with the original gateway and another device, and with an alternate gateway and another device.

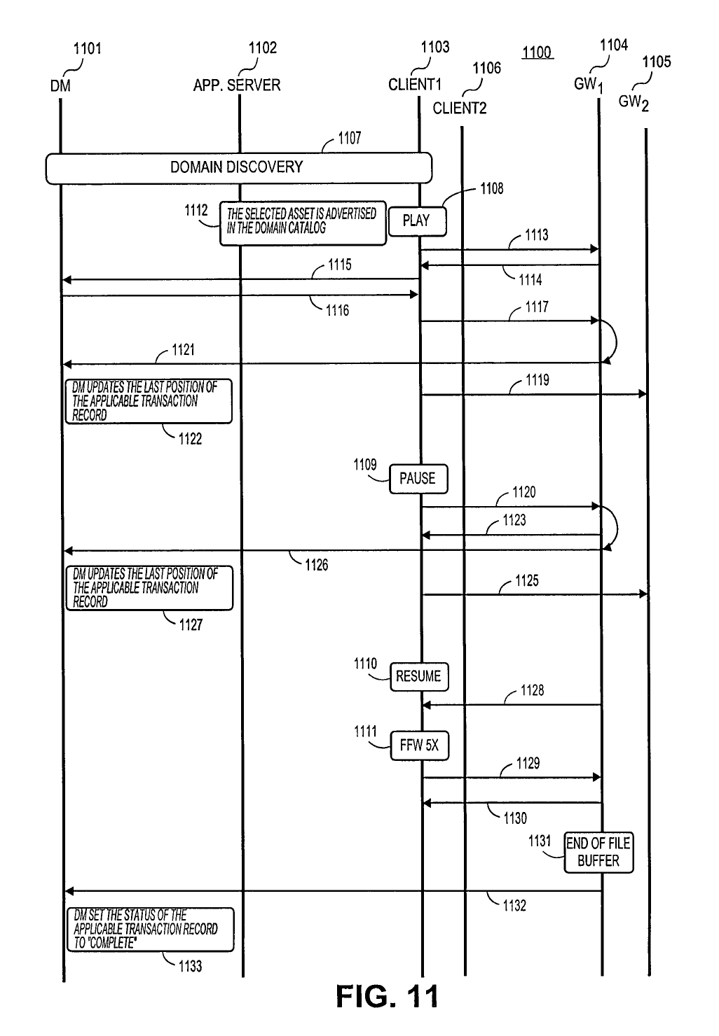

FIG. 11 is a transaction diagram 1100 illustrating an exemplary embodiment of a method to pause and resume a session from a subscriber device using the same gateway. In this scenario, a subscriber device (CLIENT1) 1103 pauses and resumes its session from a gateway (GW1) 1104.

DOMAIN DISCOVERY 1107, as the successive validation of domain association, device type identification, content path determination and adjusted catalog delivery is a prerequisite for CLIENT1 1103, as described above.

PLAY 1108 refers to sending a request for an asset of the adjusted catalog 1112 from CLIENT1 1103 to a gateway GW1 1104 at a transaction 1113, and receiving the asset from GW1 1104 at a transaction 1114. At a transaction 1115 CLIENT1 1103 has detected that the asset is encrypted and initiates a DRM license request to DM 1101, as instructed in the playlist/manifest. In this representation, the DRM License Server has been combined with the DM 1101. In response, DM returns the authorized license at a transaction 1116, which enables CLIENT1 1103 to start playback.

Upon playback state transition (e.g. from idle to play), CLIENT1 1103 calls all the gateways of the domain (e.g., GW1 1104 and GW2 1105) with the client's state and playback position (a transaction 1117 and a transaction 1119). GW1 1104 reports playback progress to DM 1101 at a transaction 1121. In response, DM updates the last position value of the applicable transaction record at block 1122. GW2 1105 does not respond to transaction 1119, as it is not involved in the connection at this time.

PAUSE 1109 refers to changing the state of CLIENT1 1103 from “play” to “pause”. CLIENT1 1103 calls all the gateways of the domain (e.g., GW1 1104 and GW2 1105) with the client's new state and playback position (a transaction 1120 and a transaction 1125). GW1 1104 replies to CLIENT1 1103 because client's state changed from play to pause at a transaction 1123. GW1 1104 reports state update and a paused position to DM 1101 at a transaction 1126, and keeps its content pipeline in place until the resources are directly requested by other connections. In response, DM 1101 updates the last position of the applicable transaction record at block 1127. GW2 1105 ignores the status update, as it is not currently providing the asset.

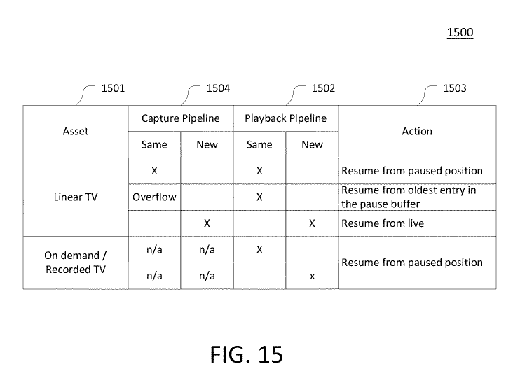

RESUME 1110 refers to GW1 1104 resuming delivering the asset at a transaction 1128. In one embodiment, GW1 1104 resumes delivering the asset to the same device from the same gateway according to a Table 1500, depicted in FIG. 15. Table 1500 covers in column 1501 the cases of Linear TV and On-demand/Recorded TV types of asset. Upon resuming and depending on how long and how busy on other connections, the gateway has been while paused, the Capture Pipeline of column 1504 can either be the same or different. If it is the same, it can still include in its pause buffer the content corresponding to the resume point or that content may have been erased to make room from newer live content. There is no capture pipeline for On-demand/Recorded content. The Playback Pipeline of column 1502 is the same when the Capture Pipeline has been preserved, and new when the Capture Pipeline has been rebuilt. In case of On-demand/Recorded content, both options are possible. In some embodiment, GW1 1104 resumes based on the action of column 1503. That is, GW1 1104 resumes from the paused position, except when the paused position is no more in the pause buffer, or the pause buffer have been terminated. In some embodiment, GW1 1104 resumes from the oldest entry in the pause buffer when the resume point has been erased, and resume from live, when the original Capture Pipeline has been terminated.

FFW 5X 1111 refers to changing at CLIENT1 1103 to a playback forward speed five times faster than real time. CLIENT1 1103 sends a request including the speed, direction and the current playback position to GW 1104 at a transaction 1129. In response, GW1 1104 generates a trick mode stream at the requested speed from the same current playback position, and delivers the asset to client 1 1103 at a transaction 1130. System and methods for generating a trick mode stream at a gateway are described in U.S. patent application Ser. No. 12/772,064, Ser. No. 12/772,066 and Ser. No. 12/772,070, all entitled “METHOD & APPARATUS FOR A PROJECTED PVR EXPERIENCE”, which are incorporated herein by reference in its entirety.

END OF FILE/BUFFER 1131 refers to GW 1 1104 detecting that the end of a file is reached (recorded content) or the pause buffer is flushed and notifying DM 1101 at a transaction 1132. In response, DM 1101 updates the status of the transaction record complete at a transaction 1133.

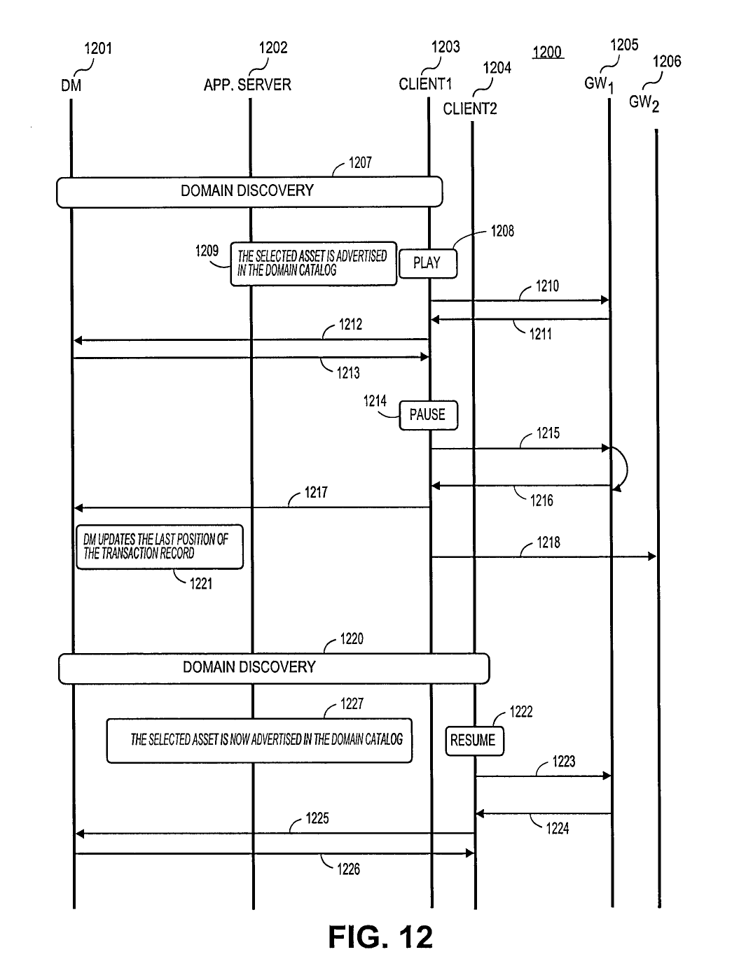

FIG. 12 is a transaction diagram 1200 illustrating an exemplary embodiment of a method to pause from one subscriber device and resume from another using the original gateway. In this scenario, a subscriber device (CLIENT1) 1103 pauses, and a subscriber device (CLIENT2) resumes the paused session from the same gateway (GW1) 1104.

DOMAIN DISCOVERY 1207, as the successive validation of domain association, device type identification, content path determination and adjusted catalog delivery is a prerequisite for CLIENT1 1203, as described above.

PLAY 1208 refers to sending a request for an asset of the adjusted catalog 1209 from CLIENT1 1203 to a gateway GW 1205 at a transaction 1210, and receiving the asset from GW 1205 at a transaction 1211. At a transaction 1212, CLIENT1 1203 has detected that the asset is encrypted and initiates a DRM license request to DM 1201, as instructed in the playlist/manifest. In this representation, the DRM License Server has been combined with the DM 1201. In response, DM returns the authorized license at a transaction 1213, which enables CLIENT1 1203 to start playback.

PAUSE 1214 refers to changing the state of the CLIENT1 1203 from “play” to “pause”. CLIENT1 1203 calls all the gateways of the domain (e.g., GW1 1205 and GW2 1206) with the client's new state and playback position (a transaction 1215 and a transaction 1218). GW1 1205 replies to CLIENT1 1203 at a transaction 1216. GW1 1205 reports a playback state update and a paused position to DM 1201 at a transaction 1217. In response, DM 1201 updates the last position of the applicable transaction record at block 1221. GW2 1206 does not respond, as it is not involved in the connection at this time.

DOMAIN DISCOVERY 1220, as the successive validation of domain association, device type identification, content path determination and adjusted catalog delivery is a prerequisite for CLIENT2 1204, after it logs in. The new adjusted catalog includes the resume position of the paused asset.

RESUME 1222 refers to CLIENT2 1204 requesting at a transition 1223 GW1 1205 to deliver the paused asset starting from the paused position. GW1 1205 resumes delivering the asset from the paused position to client 2 1204 at a transaction 1224. At a transaction 1225, CLIENT2 1204 has detected that the asset is encrypted and initiates a DRM license request to DM 1201, as instructed in the playlist/manifest. In this representation, the DRM License Server has been combined with the DM 1201. In response, DM returns the authorized license at a transaction 1226, which enables CLIENT2 1204 to start playback. In one embodiment, pause from CLIENT1 1203 and resume from CLIENT2 1204 is achieved when both subscriber devices are of different types, protected with different DRM system, or any combination hereof.

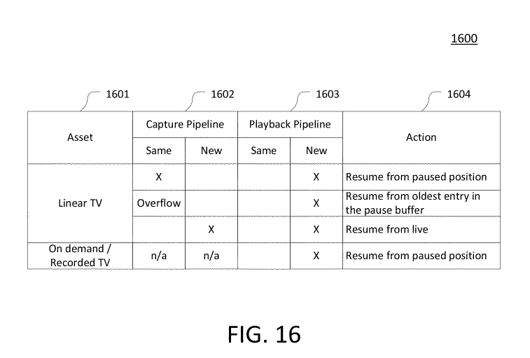

GW1 1205 resumes delivering the asset according to a Table 1600 depicted in FIG. 16. Table 1600 covers in column 1601 the cases of Linear TV and On-demand/Recorded TV types of asset. Upon resuming and depending on how long and how busy on other connections, the gateway has been while paused, the Capture Pipeline of column 1602 can either be the same or different. If it is the same, it can still include in its pause buffer the content corresponding to the resume point or that content may have been erased to make room from newer live content. There is no capture pipeline for On-demand/Recorded content. The Playback Pipeline of column 1603 is always new, as it is specific to CLIENT2 1205. In some embodiment, GW1 1205 resumes based on the action of column 1604. That is, GW1 1205 resumes from the paused position, except when the paused position is no more in the pause buffer, or the pause buffer have been terminated. In some embodiment, GW1 1205 resumes from the oldest entry in the pause buffer when the resume point has been erased, and resume from live, when the original Capture Pipeline has been terminated.

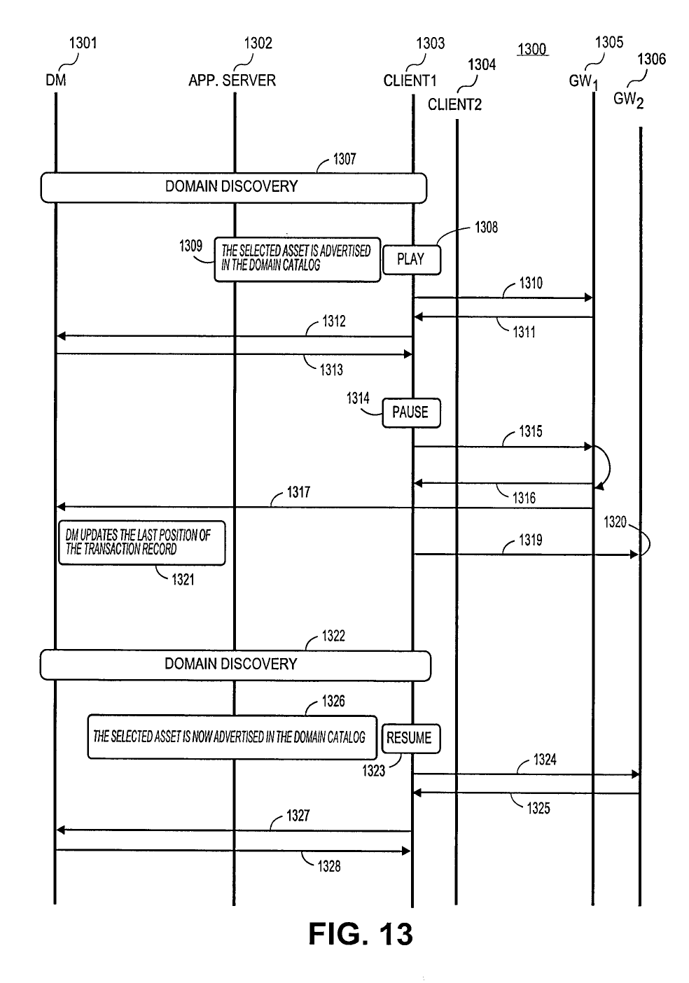

FIG. 13 is a transaction diagram 1300 illustrating an exemplary embodiment of a method to pause and resume from one subscriber device using different gateways. In this scenario, subscriber device (CLIENT1) 1303 pauses a gateway (GW1) 1305, and resumes the paused session from a gateway (GW2) 1306.

DOMAIN DISCOVERY 1307, as the successive validation of domain association, device type identification, content path determination and adjusted catalog delivery is a prerequisite for CLIENT1 1303, as described above.

PLAY 1308 refers to sending a request for an asset of the adjusted catalog 1309 from CLIENT1 1303 to a gateway GW 1305 at a transaction 1310, and receiving the asset from GW 1305 at a transaction 1311. At a transaction 1312, CLIENT1 1303 has detected that the asset is encrypted and initiates a DRM license request to DM 1301, as instructed in the playlist/manifest. In this representation, the DRM License Server has been combined with the DM 1301. In response, DM returns the authorized license at a transaction 1313, which enables CLIENT1 1303 to start playback.

PAUSE 1314 refers to changing the state of the client 1 1303 from “play” to “pause”. Client 1 1303 calls all the gateways of the domain (e.g., GW1 1305 and GW2 1306) with the client's new state and playback position (a transaction 1315 and a transaction 1319). GW1 1305 replies to client 1 1303 at a transaction 1316. GW1 1305 reports a state update and a paused position to DM 1301 at a transaction 1317. In response, DM 1301 updates the last position of the applicable transaction record at block 1321. GW2 1306 does not respond, as it is not involved in the connection at this time.

DOMAIN DISCOVERY 1322, as the successive validation of domain association, device type identification, content path determination and adjusted catalog delivery is a prerequisite for CLIENT1 1303, after it logs in again. The new adjusted catalog includes the resume position of the paused asset.

RESUME 1323 refers to CLIENT1 1303 requesting at a transaction 1324 GW2 1306 to deliver the previously paused asset starting from the paused position. GW2 1306 resumes delivering the asset from the paused position to CLIENT1 1303 at a transaction 1325. At a transaction 1312, CLIENT1 1303 has detected that the asset is encrypted and initiates a DRM license request to DM 1301, as instructed in the playlist/manifest. In this representation, the DRM License Server has been combined with the DM 1301. In response, DM returns the authorized license at a transaction 1313, which enables CLIENT1 1303 to start playback.

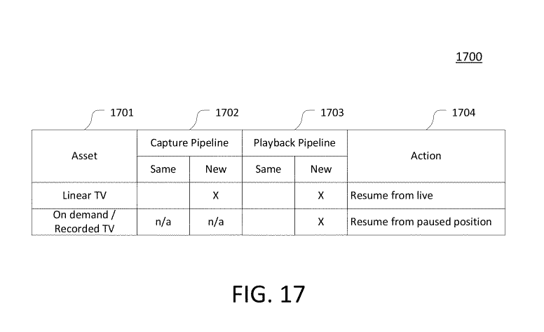

In one embodiment, GW2 1306 resumes delivering the asset according to a Table 1700 depicted in FIG. 17. Table 1700 covers in column 1701 the cases of Linear TV and On-demand/Recorded TV types of asset. The Capture Pipeline of column 1702 and Playback Pipeline of column 1703 are always new as the resuming if from a different gateway than the pausing. GW2 1306 resumes based on the action of column 1704. That is, GW1 1704 resumes from the paused position, if available. In some embodiment, GW2 1306 resumes from live when no systematic pre-emptive recording of the selected asset is available.

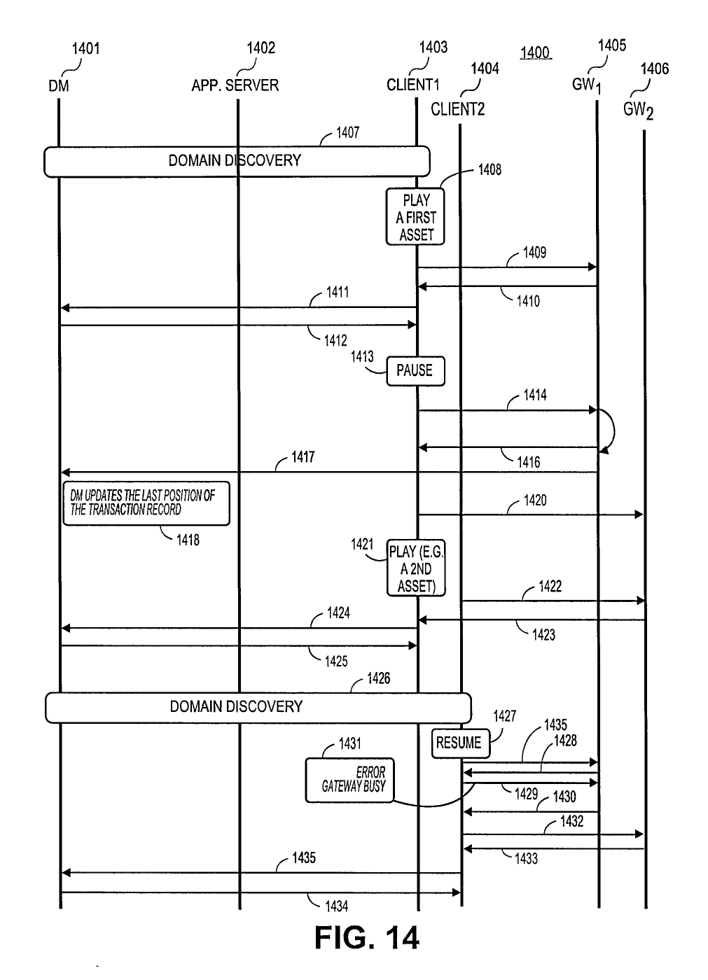

FIG. 14 is a transaction diagram 1400 illustrating an exemplary embodiment of a method to pause from one subscriber device and resume from another using different gateways. In this scenario, a subscriber device (CLIENT1) 1403 pauses a gateway (GW1) 1405, and a subscriber device (CLIENT2) resumes the paused session from a gateway (GW2) 1406.

DOMAIN DISCOVERY 1407, as the successive validation of domain association, device type identification, content path determination and adjusted catalog delivery is a prerequisite for CLIENT1 1403, as described above.

PLAY 1408 refers to sending a request for an asset of the adjusted catalog from CLIENT1 1403 to a gateway GW1 1405 at a transaction 1409, and receiving the asset from GW1 1405 at a transaction 1410. At a transaction 1411, CLIENT1 1403 has detected that the asset is encrypted and initiates a DRM license request to DM 1401, as instructed in the playlist/manifest. In this representation, the DRM License Server has been combined with the DM 1401. In response, DM returns the authorized license at a transaction 1412, which enables CLIENT1 1403 to start playback.

PAUSE 1413 refers to changing the state of CLIENT1 1403 from “play” to “pause”. CLIENT1 1403 calls all the gateways of the domain (e.g., GW1 1405 and GW2 1406) with the client's new state and playback position (a transaction 1414 and a transaction 1419). GW1 1405 replies to client 1 1403 at a transaction 1417. GW1 1405 reports a state update and a paused position to DM 1401 at a transaction 1417. In response, DM 1401 updates the last position of the applicable transaction record at a block 1418. GW2 1406 does not respond, as it is not involved in the connection at this time.

PLAY 1421 refers to sending a request for another asset of the adjusted catalog from CLIENT1 1403 to the same gateway GW1 1405 at a transaction 1422, and receiving the asset from GW1 1405 at a transaction 1423. At a transaction 1424, CLIENT1 1403 has detected that the asset is encrypted and initiates a DRM license request to DM 1401, as instructed in the playlist/manifest. In this representation, the DRM License Server has been combined with the DM 1401. In response, DM returns the authorized license at a transaction 1425, which enables CLIENT1 1403 to start another playback session. In one implementation, GW1 1405 has limited resources and had to tear down the pipelines of the paused session to support the new one.

DOMAIN DISCOVERY 1426, as the successive validation of domain association, device type identification, content path determination and adjusted catalog delivery is a prerequisite for CLIENT2 1404, after it logs in. The new adjusted catalog includes the resume position of the paused asset.

RESUME 1427 refers to CLIENT2 1404 trying to resume playing the initially selected asset from the original gateway GW1 1405 (transactions 1435 and 1429), and receiving (block 1431) a response from the GW1 1405 that it is busy (transactions 1428 and 1430). In some embodiment, CLIENT2 1404 sends a request for the same asset to GW2 1406 at a transaction 1432. GW2 1406 resumes delivering the initially selected asset from the paused position to CLIENT2 1204 at a transaction 1433. At a transaction 1435, CLIENT2 1404 has detected that the asset is encrypted and initiates a DRM license request to DM 1401, as instructed in the playlist/manifest. In this representation, the DRM License Server has been combined with the DM 1401. In response, DM returns the authorized license at a transaction 1434, which enables CLIENT2 1404 to start a playback session.

### Domain Monitoring

FIG. 2G shows an exemplary embodiment of the domain monitoring. A domain monitoring starts at a block 281. As shown in FIG. 2F, domain association data 282, player registration data 283, player type identification data 284, content distribution path determination data 285, catalog adjustment data 286, and DRM license authorization data 287 are stored in a DM database 288. That is, domain association, player registration, player type identification, content distribution path determination, catalog adjustment, and DRM license authorization services for a subscriber device 291 coupled to an application server 290 are prerequisites for the domain monitoring. Domain monitoring is performed at a block 289. In at least one embodiment, domain monitoring involves updating the license requests transactions recorded in the DM database 288 with subscriber device 291 playback updates, as reported by the providing gateway 292. In one embodiment, the playback updates includes the last play position and the current requested bitrate profile when more than one profiles are available for the device to dynamical choose.

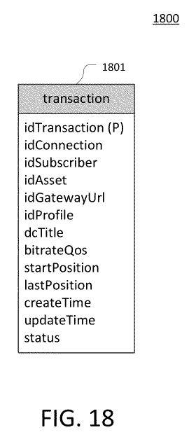

FIG. 18 is a diagram illustrating one exemplary embodiment of a data structure 1800 containing subscriber domain monitoring data. The data structure 1800 includes one record per device transaction. In one embodiment, a transaction record is created when a license authorization is requested, in another a transaction is created upon a reception of a playback update for a transaction that doesn't have yet a record (e.g. clear content).

Transaction record 1801 includes a transaction identifier (idTransaction (P)), a connection identifier (idConnection), a subscriber identifier (idSubscriber), an asset identifier (idAsset), a gateway URL identifier (idGatewayUrl), a profile identifier (idProfile), and one or more parameters. In some embodiments, the parameters include an optional dcTitle value to identify user content, a Qos parameter (bitrateQoS) to represent bitrate consumption, a playback position when the transaction is created (startPosition), a playback position when the transaction is updated (endPosition), a time when the transaction record is created (createTime), a time when the transaction record is last updated (updateTime), and a transaction status. In one embodiment, the bitrateQos parameter represents the bitrate usage distribution over the period of the transaction (endPosition-startPosition).

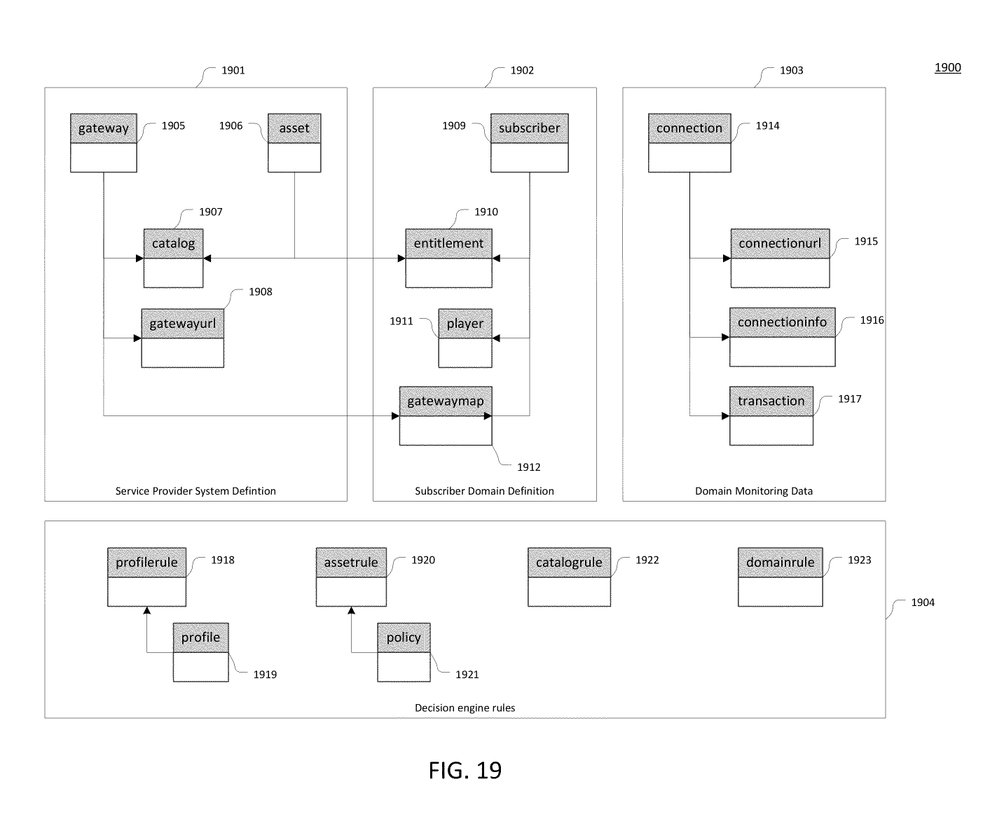

FIG. 19 illustrates an exemplary embodiment of a database 1900 that includes the data structure 1800 of FIG. 18. The idConnection identifier is a pointer to the connection 1914 table and the related connectionurl 1915 and connectioninfo 1917 tables. A connection record is created every time a subscriber device performs a domain discovery sequence, as described above. The idSubscriber is a pointer to the subscriber 1900 table and the related entitlement 1910, player 1911 and gatewaymap 912 tables. The subscriber and dependent tables store the result of the domain association method. The idAs set is a pointer to the asset 1901 table and related catalog 1907 table. The asset and catalog tables are used to generate the adjusted catalog. The idGatewayUrl is a pointer to the gatewayurl 1908 table and the related gateway 1905 table. The gatewayurl table has one record per gateway content distribution path identifier; the gateway table has one record per gateway. The idProfile is a pointer to the profile 1919 table. The profile table has one record per supported format. That is, a transaction uniquely identifies a unit of media content as a combination of an asset and a profile. Other tables include a profilerule 1918 table to define how a subscriber device is identified, an assetrule 1920 table to partially define how a license request is authorized, a catalogrule 1922 table to define how an adjusted catalog is created, a domainrule 1923 table to define how a device is registered. In one embodiment, a policy 1921 table is defined to update the rights of the authorized DRM license.

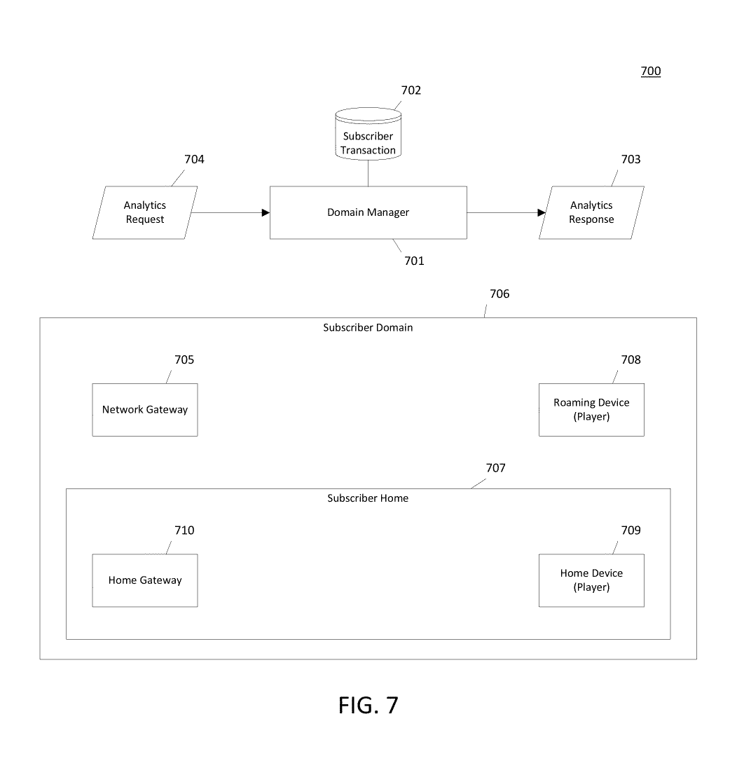

FIG. 7 is a diagram illustrating an exemplary embodiment of a system 700 to provide domain analytics based on domain monitoring data. As shown in FIG. 7, in response to an analytics request input 704, a domain manager 701 outputs an analytics response 703 based on transaction data recorded in a database 702. As shown in FIG. 7, a subscriber domain at a given time 706 comprises of a subscriber home 707 having a home gateway 710 and a subscriber device at home 709. Subscriber domain 706 further includes a network gateway 705 and a roaming subscriber device 708.

In at least one embodiment, a domain playback session can be defined as a series of transactions for the same asset within a same domain. That is, when a session is paused and resumed on a different device, or on a same device but in the context of a different connection, successive transactions can be aggregated as one session for the purpose of consumption reporting.

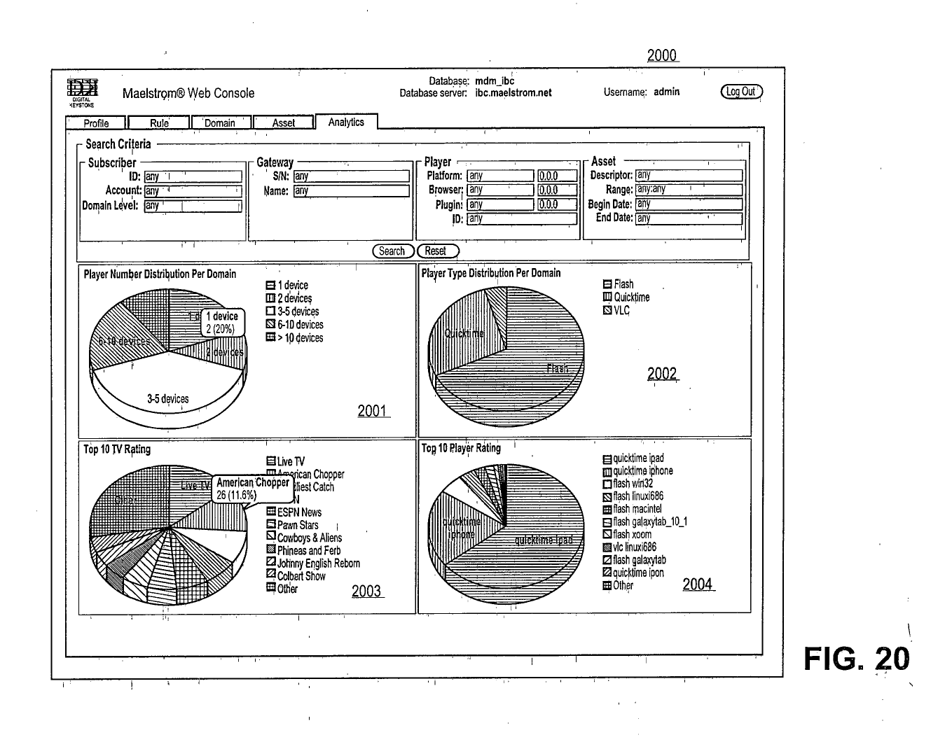

FIG. 20 illustrates an exemplary embodiment of an application that displays domain analytics based on an analytics request 704, and the corresponding analytics response 703 from DM 701. As shown in FIG. 20, a graphical user interface 2000 has one or more charts. A chart 2001 shows how the number of players per domain is distributed. A chart 2002 shows how the type of players per domain is distributed. A chart 2003 shows the top 10 asset in term of audience. A chart 2004 shows the top 10 player type in term of usage.

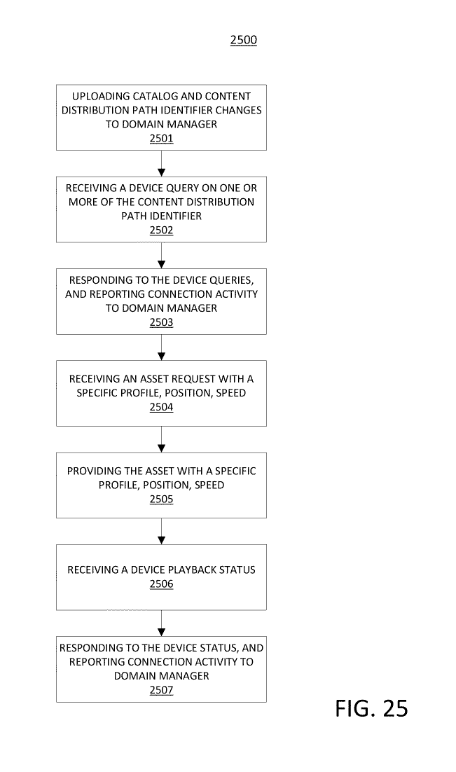

FIG. 25 shows a flowchart of an exemplary embodiment of a method 2500 at a gateway to manage media content, as described herein. Method 2500 starts with operation 2501 that involves uploading catalog data to the DM. The gateway catalog data include the gateway (e.g. URLs or IP addresses), and the list of assets and format that the gateway can provided. At operation 2502, a query on one or more of the advertised content distribution path identifiers is received. The gateway responds to the caller at operation 2503, and reports the connection activity to the DM. This information is critical to the generation of the adjusted catalog.

At operation 2504, a request for one of the advertised asset is received with a specific profile, position and speed. The gateway provides the asset in the format request at operation 2505. In some implementation, the asset in the requested format is pre-packaged and ready to be delivered, in some other the operations of packaging are happening upon request.

At operation 2506, a notification of a playback status is received from one of the active subscriber devices. In one implementation, the playback status is received when the subscriber device is changing state (e.g., from “play” to “pause”, “pause” to “play”, “play” to “fast forward”, “fast forward” to “play”, “play” to “stop”, “stop” to “play”, and other status change), in some other a playback status is sent periodically by the subscriber device. The gateway responds to the caller at operation 2507, and reports the connection activity to the DM.

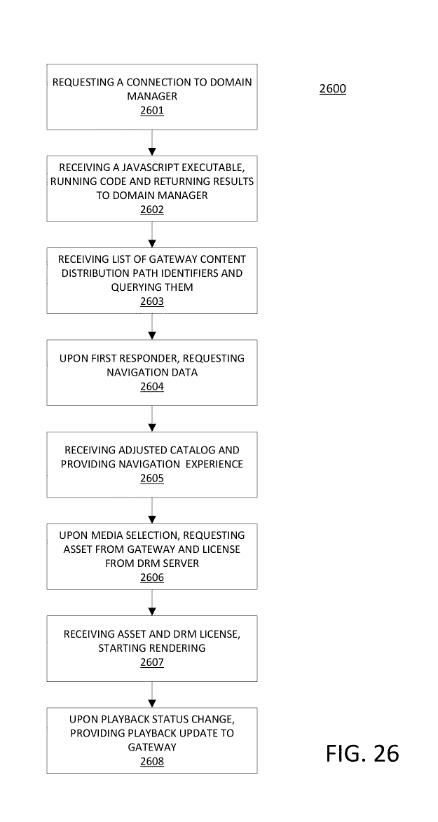

FIG. 26 shows a flowchart of an exemplary embodiment of a method 2600 at a subscriber device to manage media content, as described herein. At operation 2601, a request for connection is sent directly or via an application server to a DM. The request for connection includes the username of the subscriber. In one embodiment, the request for connection also includes an identifier for the operator network. At operation 2602, the client receives an executable code (e.g. JavaScript) to be run on the device for device type identification. The results of the provided code execution are returned directly or via an application server to a DM.

In response, the subscriber device receives at operation 2603 a list of possible content distribution path identifiers associated to the subscriber domain and starts querying all the identifiers. Successful queries are reported by the domain gateways to the DM to determine which content distribution paths are operational. After a first gateway responded to the identifier queries, a request for navigation data is sent to an application server at operation 2604. In some embodiment the navigation data includes an adjusted catalog provided by the DM.

Upon reception of the adjusted catalog and other navigation data, a complete navigation experience is generated for the purpose of content selection at operation 2605. Upon selection, a request for the asset to the source gateway and then a request to the DRM license server are sent at operation 2606. After receiving both the asset and matching DRM license, the subscriber device start rendering at operation 2607.

At operation 2608, a playback status update is sent to the sourcing gateway. In some implementation, playback updates are sent after detection of a change of playback state by the subscriber device, in some other the updates are sent periodically.

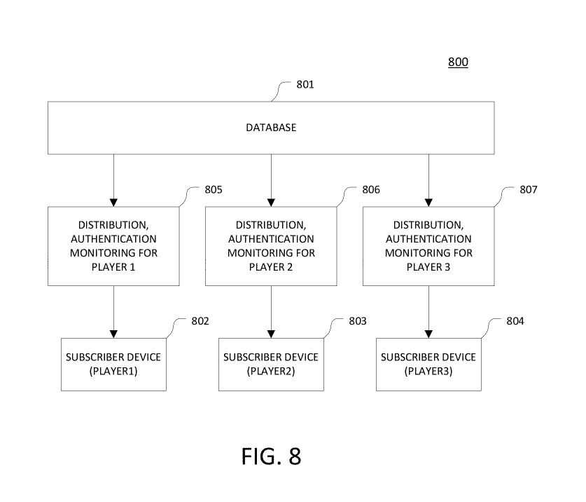

FIG. 8 is a block diagram illustrating an alternate embodiment of a system to provide domain distribution, authorization, and monitoring. As shown in FIG. 8, system 800 includes a source database 801 on top of a plurality of domain distribution/authorization/monitoring systems 805, 806, and 807. System 800 includes a plurality of different types of subscriber devices, such as devices 802, 803, and 804. For example, device 802 is an iPad, device 803 is a smart TV, and device 804 is a personal computer (PC). Each of the different domain distribution/authorization/monitoring systems 805-807 is connected to each of the subscriber devices 802-804. That is, each of the client devices has its own domain distribution/authorization/monitoring system, and a database on top of them that collects all the information from all different modules. Building and operating system 800 can be much more expensive and time consuming than the systems described above with respect to FIGS. 1-7, and 9-27.

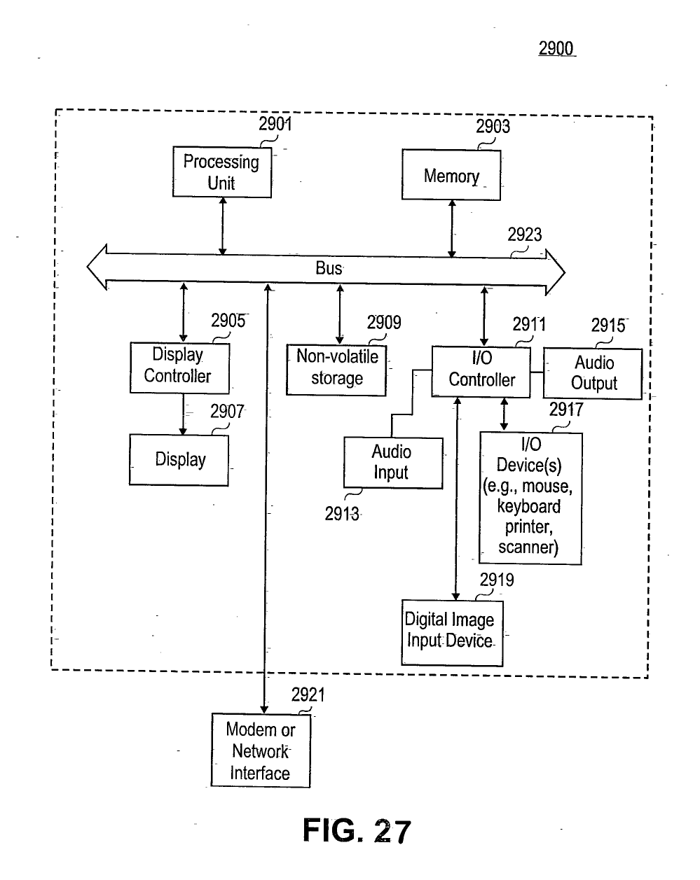

FIG. 27 shows a block diagram of one embodiment of a data processing system to provide domain management, as described herein. Data processing system 2900 includes a processing unit 2901 that may include a microprocessor or microprocessor, such as Intel microprocessor (e.g., Core i7, Core 2 Duo, Core 2 Quad, Atom), Sun Microsystems microprocessor (e.g., SPARC), IBM microprocessor (e.g., IBM 750), Motorola microprocessor (e.g., Motorola 68000), Advanced Micro Devices (“AMD”) microprocessor, Texas Instrument microcontroller, and any other microprocessor or microcontroller.

Processing unit 2901 may include a personal computer (PC), such as a Macintosh® (from Apple Inc. of Cupertino, Calif.), Windows®-based PC (from Microsoft Corporation of Redmond, Wash.), or one of a wide variety of hardware platforms that run the UNIX operating system or other operating systems. In at least some embodiments, processing unit 2901 includes a general purpose or specific purpose data processing system based on Intel, AMD, Motorola, IBM, Sun Microsystems, IBM processor families, or any other processor families. As shown in FIG. 29, memory 2903 is coupled to the processing unit 2901 by a bus 2923.

Memory 2903 can be dynamic random access memory (DRAM) and can also include static random access memory (SRAM). A bus 2923 couples processing unit 2901 to the memory 2903 and also to non-volatile storage 2909 and to display controller 2905 (if a display is used) and to the input/output (I/O) controller(s) 2911. Display controller 2905 controls in the conventional manner a display on a display device 2907 which can be a cathode ray tube (CRT), liquid crystal display (LCD), or any other display device. The input/output devices 2917 can include a keyboard, disk drives, printers, a scanner, a camera, and other input and output devices, including a mouse or other pointing device. The I/O controller 2911 is coupled to one or more audio input devices 2913, for example, one or more microphones.

The display controller 2905 and the I/O controller 2911 can be implemented with conventional well known technology. An audio output 2915, for example, one or more speakers may be coupled to an I/O controller 2911. The non-volatile storage 2909 is often a magnetic hard disk, an optical disk, or another form of storage for large amounts of data. Some of this data is often written, by a direct memory access process, into memory 2903 during execution of software in the data processing system 2900 to perform methods described herein.

One of skill in the art will immediately recognize that the terms “computer-readable medium” and “machine-readable medium” include any type of storage device that is accessible by the processing unit 2901. A data processing system 2900 can interface to external systems through a modem or network interface 2921. It will be appreciated that the modem or network interface 2921 can be considered to be part of the data processing system 2900. This interface 2921 can be an analog modem, ISDN modem, cable modem, token ring interface, satellite transmission interface, or other interfaces for coupling a data processing system to other data processing systems.

It will be appreciated that data processing system 2900 is one example of many possible data processing systems which have different architectures. For example, personal computers based on an Intel microprocessor often have multiple buses, one of which can be an input/output (I/O) bus for the peripherals and one that directly connects the processing unit 2901 and the memory 2903 (often referred to as a memory bus). The buses are connected together through bridge components that perform any necessary translation due to differing bus protocols.

Network computers are another type of data processing system that can be used with the embodiments as described herein. Network computers do not usually include a hard disk or other mass storage, and the executable programs are loaded from a network connection into the memory 2903 for execution by the processing unit 2901. A typical data processing system will usually include at least a processor, memory, and a bus coupling the memory to the processor.

It will also be appreciated that the data processing system 2900 can be controlled by operating system software which includes a file management system, such as a disk operating system, which is part of the operating system software. Operating system software can be the family of operating systems known as Macintosh® Operating System (Mac OS®) or Mac OS X® from Apple Inc. of Cupertino, Calif., or the family of operating systems known as Windows® from Microsoft Corporation of Redmond, Wash., and their associated file management systems. The file management system is typically stored in the non-volatile storage 2909 and causes the processing unit 2901 to execute the various acts required by the operating system to input and output data and to store data in memory, including storing files on the non-volatile storage 2909.

In various embodiments, hardwired circuitry may be used in combination with software instructions to implement methods described herein. A machine readable medium can be used to store software and data which when executed by a data processing system causes the system to perform various methods described herein. This executable software and data may be stored in various places including for example ROM, volatile RAM, non-volatile memory, and/or cache. Portions of this software and/or data may be stored in any one of these storage devices.

Thus, a machine readable medium includes any mechanism that provides (i.e., stores and/or transmits) information in a form accessible by a machine (e.g., a computer, network device, or any device with a set of one or more processors, etc.). For example, a machine readable medium includes recordable/non-recordable media (e.g., read only memory (ROM); random access memory (RAM); magnetic disk storage media; optical storage media; flash memory devices; and the like.

The methods as described herein can be implemented using dedicated hardware (e.g., using Field Programmable Gate Arrays, or Application Specific Integrated Circuit) or shared circuitry (e.g., microprocessors or microcontrollers under control of program instructions stored in a machine readable medium. The methods as described herein can also be implemented as computer instructions for execution on a data processing system, such as system 2900 of FIG. 29.

In the foregoing specification, embodiments as described herein have been described with reference to specific exemplary embodiments thereof. It will be evident that various modifications may be made thereto without departing from the broader spirit and scope of the embodiments as described herein. The specification and drawings are, accordingly, to be regarded in an illustrative sense rather than a restrictive sense.

What is claimed is:

1. A method at a server to distribute media content within a subscriber domain, comprising:
(1) associating one or more gateways, one or more entitlements and one or more domain rights applicable to the subscriber domain;
(2) registering a subscriber device to the subscriber domain;
(3) identifying a type of the subscriber device;
(4) determining one or more content distribution paths to the associated gateways for the subscriber device;
creating an adjusted catalog of media content based on (1) the associating; (2) the registering, (3) the identifying, and (4) the determining; and
providing the adjusted catalog to a navigation application rendered on the subscriber device.

2. A method as in claim 1, wherein the associated one or more gateways includes one or more home gateways, one or more network gateways, or any combination thereof.

3. A method as in claim 1, wherein the determined one or more content distribution paths to the associated gateways include a broadcast legacy CDN, a private or public transparent Internet Protocol based CDN, a private or public opaque Internet Protocol based CDN, a home private network or a combination thereof.

4. A method as in claim 1, wherein the associated one or more entitlements include one or more subscription rights of media content, one or more rental rights of media content, one or more purchase rights of media content, or any combination thereof.

5. A method as in claim 1, wherein the associated one or more domain rights defines how and how many subscriber client devices can be registered to the subscriber domain.

6. A method as in claim 1, further comprising controlling a registration of a new subscriber device based on the one or more associated domain rights.

7. A method as in claim 1, wherein subscriber devices registered to the subscribed domain are protected with different Digital Rights Management systems.

8. A method as in claim 1, wherein the subscriber device is characterized using a list of device profiles.

9. A method as in claim 1, wherein the subscriber device is localized using the one or more associated gateways.

10. A method as in claim 1, wherein the catalog of media content is adjusted according to
an availability of the media content in the one or more associated gateways;
a processing capability of the one or more associated gateways;
availability of the one or more gateway content distribution paths;
characteristics of the subscriber device;
relative locations of the one or more gateways relative to the subscriber device;
the one or more subscriber domain entitlements;
one or more content distribution rights of the service providers to the subscriber device;
a past consumption state of each media content within the subscriber domain; or
any combination thereof.

11. A method of claim 10, wherein the adjusting of the catalog includes creating a subscriber device specific catalog for a connection by performing one or more of the following actions
merging all reachable gateway assets;
removing an asset that is not reachable;
removing a format that is not playable per asset;
marking or removing an asset that is not entitled;
filtering assets on a per category basis;
adding domain resume points to each asset; and
listing all available content distribution paths per asset.

12. A method as in claim 1, wherein changes of the subscriber domain triggers an update of the adjusted catalog; and
an update of a notification to the navigation application rendered on the subscriber device.

13. A method at a server to authorize distribution of media content within a subscriber domain of devices, comprising:
receiving a license request for the media content from a subscriber device, wherein the license request references data associated with the subscriber device that has been registered to a subscriber domain comprising one or more gateways, one or more entitlements and one or more domain rights applicable to the subscriber domain; the subscriber device having a subscriber device type that has been identified; and having one or more content distribution paths to the associated gateways that have been determined;
authorizing a creation of a license for the media content, wherein the authorizing is based upon (1) associating one or more gateways, one or more entitlements and one or more domain rights applicable to the subscriber domain;
(2) registering the subscriber device to the subscriber domain; (3) identifying a type of the subscriber device; and (4) determining one or more content distribution paths to the associated gateways for the subscriber device; and
delivering the license to the subscriber device.

14. A method as in claim 13, wherein the associated one or more gateways includes one or more home gateways, one or more network gateways, or any combination thereof.

15. A method as in claim 13, wherein the determined one or more content distribution paths to the associated gateways include a broadcast legacy CDN, a private or public transparent Internet Protocol based CDN, a private or public opaque Internet Protocol based CDN, a home private network or a combination thereof.

16. A method as in claim 13, wherein the associated one or more entitlements include one or more subscription rights of media content, one or more rental rights of media content, one or more purchase rights of media content.

17. A method as in claim 13, where the associated one or more domain rights defines how and how many subscriber client devices can be registered to the subscriber domain.

18. A method as in claim 13, further comprising
controlling a registration of one or more new subscriber devices based on the associated one or more domain rights.

19. A method as in claim 13, wherein one or more subscriber devices registered to the subscriber domain are protected with different Digital Rights Management systems.

20. A method as in claim 13, wherein the authorizing is according to
an integrity of the license request;
a DRM identity of the subscriber device;
availability of the one or more gateway content distribution paths;
relative locations of the one or more gateways to the subscriber device;
one or more subscriber domain entitlements;
one or more content distribution rights of the service providers to the subscriber device;
a past consumption state of each media content within the subscriber domain; or
any combination thereof.

21. A method at a server to monitor a distribution of media content within a subscriber domain of devices, comprising:
receiving at least one of one or more license request transactions for the media content from a subscriber device and one or more playback state transitions of subscriber device reports referencing data associated with the subscriber device that has been registered to a subscriber domain comprising one or more gateways, one or more entitlements and one or more domain rights applicable to the subscriber domain; the subscriber device having a subscriber device type that has been identified; and having one or more content distribution paths to the associated gateways that have been determined; and
recording a context of the at least one of the one or more license request transactions and the one or more playback state transitions of subscriber device reports.

22. A method as in claim 21, wherein the associated CDNs include a broadcast legacy distribution network, a transparent Internet Protocol based distribution network, an opaque Internet Protocol based distribution network, or a combination thereof.

23. A method as in claim 21, wherein the associated gateways includes one or more home gateways, one or more in-network media servers, one or more out-of-network media servers, or any combination thereof.

24. A method as in claim 21, wherein the associated one or more entitlements include one or more subscription rights of media content, one or more rental rights of media content, one or more purchase rights of media content, or any combination thereof.

25. A method as in claim 21, where the associated one or more domain rights defines how and how many subscriber client devices can be registered to the subscriber domain.

26. A method as in claim 21, further comprising
controlling a registration of a new subscriber device based on the one or more associated domain rights.

27. A method as in claim 21, wherein recording the context of the at least one of the one or more license request transactions includes
an identifier of the subscriber client;
an identifier of the gateway providing the media content;
an identifier of the media content;
an identifier of the subscriber domain;
an identifier of the adjusted catalog that has been used to request the media content;
an identifier of the format of the media content;
a time of a transaction;
a position within the media content where a playback started;
a status of the transaction;
or any combination thereof.

28. A method as in claim 21, wherein recording the context of the at least one of the one or more playback state transitions of the subscriber device reports includes
recording a position within the media content at a time of the playback state transition,
a bitrate distribution profile from a beginning of a playback to the time of the playback state transition;
a status of a transaction;
or any combination thereof.

29. A machine-readable medium storing executable program instructions which when executed by a data processing system cause the system to perform a method to distribute media content within a subscriber domain, comprising:
(1) associating one or more gateways, one or more entitlements and one or more domain rights applicable to the subscriber domain;
(2) registering a subscriber device to the subscriber domain;
(3) identifying a type of the subscriber device;
(4) determining one or more content distribution paths to the associated gateways for the subscriber device;
creating an adjusted catalog of media content based on (1) the associating; (2) the registering, (3) the identifying, and (4) the determining; and
providing the adjusted catalog to a navigation application rendered on the subscriber device.

30. A machine-readable medium as in claim 29, wherein the associated one or more CDNs include a broadcast network, a managed Internet Protocol based network, an unmanaged Internet Protocol based network, or a combination thereof.

31. A machine-readable medium as in claim 29, wherein the associated one or more gateways includes one or more home gateways, one or more in-network media servers, one or more out-of-network media servers, or any combination thereof.

32. A machine-readable medium as in claim 29, wherein the associated one or more entitlements include one or more subscription rights of media content, one or more rental rights of media content, one or more purchase rights of media content, or any combination thereof.

33. A machine-readable medium as in claim 29, wherein the associated one or more domain rights defines how and how many subscriber client devices can be registered to the subscriber domain.

34. A machine-readable medium as in claim 29, further comprising instructions that cause the system to perform operations comprising controlling a registration of a new subscriber device based on the one or more associated domain rights.

35. A machine-readable medium as in claim 29, wherein subscriber devices registered to the subscribed domain are protected with different Digital Rights Management systems.

36. A machine-readable medium as in claim 29, wherein the subscriber device is characterized using a list of device profiles.

37. A machine-readable medium as in claim 29, wherein the subscriber device is localized using the one or more associated gateways.

38. A machine-readable medium as in claim 29, wherein the catalog of media content is adjusted according to
an availability of the media content in the one or more associated gateways;
a processing capability of the one or more associated gateways;
availability of the one or more gateway content distribution paths;
characteristics of the subscriber device;
relative locations of the one or more gateways relative to the subscriber device;
the one or more subscriber domain entitlements;
one or more content distribution rights of the service providers to the subscriber device;
a past consumption state of each media content within the subscriber domain; or
any combination thereof.

39. A machine-readable medium as in claim 38, wherein the adjusting of the catalog includes creating a subscriber device specific catalog for a connection by performing one or more of the following actions
merging all reachable gateway assets;
removing an asset that is not reachable;
removing a format that is not playable per asset;
marking or removing an asset that is not entitled;
filtering assets on a per category basis;
adding domain resume points to each asset; and
listing all available content distribution paths per asset.

40. A machine-readable medium as in claim 29, wherein changes of the subscriber domain triggers
an update of the adjusted catalog; and
an update of a notification to the navigation application rendered on the subscriber device.

41. A machine-readable medium storing executable program instructions which when executed by a data processing system cause the system to perform a method to authorize distribution of media content within a subscriber domain of devices, comprising:
receiving a license request for the media content from a subscriber device, wherein the license request references data associated with the subscriber device that has been registered to a subscriber domain comprising one or more gateways, one or more entitlements and one or more domain rights applicable to the subscriber domain; the subscriber device having a subscriber device type that has been identified; and having one or more content distribution paths to the associated gateways that have been determined;
authorizing a creation of a license for the media content, wherein the authorizing is based upon (1) associating one or more gateways, one or more entitlements and one or more domain rights applicable to the subscriber domain;
(2) registering the subscriber device to the subscriber domain; (3) identifying a type of the subscriber device; and (4) determining one or more content distribution paths to the associated gateways for the subscriber device; and
delivering the license to the subscriber device.

42. A machine-readable medium as in claim 41, wherein the associated one or more CDNs include a broadcast legacy distribution network, a transparent Internet Protocol based distribution network, an opaque Internet Protocol based distribution network, or a combination thereof.

43. A machine-readable medium as in claim 41, wherein the associated one or more gateways includes one or more home gateways, one or more in-network media servers one or more out-of-network media servers, or any combination thereof.

44. A machine-readable medium as in claim 41, wherein the associated one or more entitlements include one or more subscription rights of media content, one or more rental rights of media content, one or more purchase rights of media content.

45. A machine-readable medium as in claim 41, where the associated one or more domain rights defines how and how many subscriber client devices can be registered to the subscriber domain.

46. A machine-readable medium as in claim 41, further comprising instructions that cause the system to perform operations comprising
controlling a registration of one or more new subscriber devices based on the associated one or more domain rights.

47. A machine-readable medium as in claim 41, wherein one or more subscriber devices registered to the subscriber domain are protected with different Digital Rights Management systems.

48. A machine-readable medium as in claim 41, wherein the authorizing is according to
an integrity of the license request;
a DRM identity of the subscriber device;
availability of the one or more gateway content distribution paths;
relative locations of the one or more gateways to the subscriber device;
the one or more subscriber domain entitlements;
one or more content distribution rights of the service providers to the subscriber device;
a past consumption state of each media content within the subscriber domain; or
any combination thereof.

49. A machine-readable medium storing executable program instructions which when executed by a data processing system cause the system to perform a method to monitor a distribution of media content within a subscriber domain of devices, comprising:
receiving at least one of one or more license requests for the media content from a subscriber device and one or more playback state transitions of a subscriber device reports referencing data associated with the subscriber device that has been registered to a subscriber domain comprising one or more content distribution networks (CDNs), one or more gateways, one or more entitlements and one or more domain rights applicable to the subscriber domain; the subscriber device having a subscriber device type that has been identified; and having one or more content distribution paths to the associated gateways that have been determined; recording all license requests for the media content from a subscriber device; and
recording the context of the at least one of the one or more license requests and the one or more playback state transitions.

50. A machine-readable medium as in claim 49, wherein the associated CDNs a broadcast legacy distribution network, a transparent Internet Protocol based distribution network, an opaque Internet Protocol based distribution network, or a combination thereof.

51. A machine-readable medium as in claim 49, wherein the associated gateways includes one or more home gateways, one or more in-network media servers, one or more out-of-network media servers, or any combination thereof.

52. A machine-readable medium as in claim 49, wherein the associated one or more entitlements include one or more subscription rights of media content, one or more rental rights of media content, one or more purchase rights of media content, or any combination thereof.

53. A machine-readable medium as in claim 49, wherein the associated one or more domain rights defines how and how many subscriber client devices can be registered to the subscriber domain.

54. A machine-readable medium as in claim 49, further comprising instructions that cause the system to perform operations comprising
controlling a registration of a new subscriber device based on the one or more associated domain rights.

55. A machine-readable medium as in claim 49, wherein recording the context of the at least one of the one or more license request transactions includes
an identifier of the subscriber client;
an identifier of the gateway providing the media content;
an identifier of the media content;
an identifier of the subscriber domain;
an identifier of the adjusted catalog that has been used to request the media content;
an identifier of the format of the media content;
a time of a transaction;
a position within the media content where a playback started;
a status of the transaction;
or any combination thereof.

56. A machine-readable medium as in claim 49, wherein recording the context of the at least one of the one or more playback state transitions of the subscriber device reports includes
recording a position within the media content at a time of the playback state transition,
a bitrate distribution profile from a beginning of a playback to the time of the playback state transition;
a status of a transaction;
or any combination thereof.

57. A data processing system to distribute media content within a subscriber domain, comprising:
means for (1) associating one or more gateways, one or more entitlements and one or more domain rights applicable to the subscriber domain;
means for (2) registering a subscriber device to the subscriber domain;
means for (3) identifying a type of the subscriber device;
means for (4) determining one or more content distribution paths to the associated gateways for the subscriber device;
means for creating an adjusted catalog of media content based on (1) the associating; (2) the registering, (3) the identifying, and (4) the determining; and
means for providing the adjusted catalog to a navigation application rendered on the subscriber device.

58. A data processing system to authorize the distribution of media content within a subscriber domain of devices, comprising:
means for receiving a license request for the media content from a subscriber device, wherein the license request references data associated with the subscriber device that has been registered to a subscriber domain comprising one or more gateways, one or more entitlements and one or more domain rights applicable to the subscriber domain; the subscriber device having a subscriber device type that has been identified; and having one or more content distribution paths to the associated gateways that have been determined;
means for authorizing a creation of a license for the media content, wherein the authorizing is based upon (1) associating one or more gateways, one or more entitlements and one or more domain rights applicable to the subscriber domain; (2) registering the subscriber device to the subscriber domain; (3) identifying a type of the subscriber device; and (4) determining one or more content distribution paths to the associated gateways for the subscriber device; and
means for delivering the license to the subscriber device.

59. A data processing system to monitor a distribution of media content within a subscriber domain of devices, comprising:
means for receiving at least one of one or more license requests for the media content from a subscriber device and one or more playback state transitions of a subscriber device reports referencing data associated with the subscriber device that has been registered to a subscriber domain comprising one or more gateways, one or more entitlements and one or more domain rights applicable to the subscriber domain; the subscriber device having a subscriber device type that has been identified; and having one or more content distribution paths to the associated gateways that have been determined; and
means for recording all license requests for the media content from a subscriber device; and
means for recording the context of the at least one of the one or more license requests and the one or more playback state transitions.
